(19) United States
(12) Patent Application Publication
(10) Pub. No.: US 2004/0025389 A1
(43) Pub. Date: Feb. 12, 2004

(54) Continuous advertising medium and medium display device

(76) Inventor: Lee M. Peterson, Maplewood, MN (US)

Correspondence Address: MOORE, HANSEN & SUMNER, 2900 WELLS FARGO CENTER, 90 SOUTH SEVENTH STREET, MINNEAPOLIS, MN, 55402, US

(21) Appl. No.: 10/398,969

(22) PCT Filed: Feb. 20, 2002
(86) PCT No.: PCT/US02/05499

(51) Int. Cl. G09F 11/12

(52) U.S. Cl. 40/524

(57) ABSTRACT

The present invention provides an advertising display device for displaying a continuous advertising medium (8). The display device includes a tracking apparatus (10) providing adjustable track (12). The tracking apparatus includes a frame (14) operatively connected with first and second rollers (16, 18) defining opposite ends of the adjustable track; the adjustable track having an operative configuration, a non-operative configuration and an adjustable track length; the adjustable track length being the distance between the most distal point on each of the respective rollers. One of the first and second rollers is a drive roller that provides a motive force that rotates the medium about the adjustable track when the medium is engaged with the track and it is in the operative configuration. One of the first and second roller is a tension roller that is adjustably connected to the frame. The tracking apparatus also includes light source (42) attached to the frame and positioned in a manner in which the continuous advertising medium rotates around the light source. The medium is preferably made of materials through which light can pass and the display device preferably includes a light source positioned to backlight a single thickness of the medium.

### RELATED APPLICATIONS

The present application discloses invention subject matter that is disclosed at least in part, if not fully disclosed, in three prior provisional applications filed by or on behalf of the present inventor; U.S. Patent Application No. 60/269,989, filed Feb. 20, 2001; No. 60/327,421, filed Oct. 5, 2001 and No. 60/328,237, filed Oct. 10, 2001, each of which is entitled: CONTINUOUS ADVERTISING MEDIUM DISPLAY DEVICE.

### FIELD OF THE INVENTION

The present invention relates to advertising media and media display devices for displaying images, such as advertisements and promotional materials, printed and displayed on such media; more specifically to continuous advertising media and continuous advertising medium display devices haying rollers upon which a continuous advertising medium turns so as to enable periodic or continuous change of the images displayed. The rollers are adjustable to allow the advertising medium to be easily removed from the rollers and changed so that a different advertising medium having different images, preferably advertisements, can be placed in the respective display device. The continuous advertising medium is preferably made of materials through which light may pass and the continuous advertising medium display device preferably includes a light source positioned to backlight a single thickness of the continuous advertising medium.

### BACKGROUND OF THE INVENTION

Advertising is a multi-billion dollar industry in the United States alone. Stationary signage is priced based in part upon location, square footage and time displayed. Changing the signage, however, is time consuming and expensive and the cost of this activity must be born by the advertiser. It will be appreciated, therefore, that signage which can be easily changed has a value in that the cost of changing the signage will be minimized.

In recent years, various devices for the display of repetitive advertising messages have been developed. Signs that display one sign, then change to another and perhaps even another are attention catching and are, therefore, desirable to advertisers and owners of advertising venues. Unfortunately, it is difficult to change the repetitive signs that appear on these displays for a number of reasons that are particular to the displays themselves.

For example, devices in which messages are placed on a series of surfaces of a series of prismatic members that rotate about horizontal or vertical axes to expose the various surfaces in a coordinated manner and thus display the various messages in a succession of different displays are eye catching. It is very difficult, however, to change the various images on the various surfaces of the various prismatic members. Such a device is described in U.S. Pat. No. 4,780,001 to Werner and has been marketed under the trademark TRI-VISION® by Werner Tool & Manufacturing Company of Detroit, Minn. This device has a number of limitations, however, including the limited number of advertisements that can be displayed, usually three, and the great difficulty associated with changing the images that are displayed on each of the surfaces of each of the prismatic members. It will be appreciated that to change the advertisements displayed in a TRI-VISION® type device, each of the surfaces in any series of coordinated sides must be changed out. This is generally rather time consuming and generally requires special familiarity with the device housing the prismatic members.

Other devices in which changeable signage is presented include scrolling signs. These devices provide a method for changing the information that is displayed on the sign, but, as with the TRI-VISION® like devices, it is believed to be labor intensive to change the signage, thereby limiting the flexibility of the device for the sign owner, when it becomes desirable to change the signage. Change generally requires specialized assistance from someone familiar with working with these signs and, therefore, a service contract is generally believed to be required to address these needs.

Translucent graphic images in backlit signs are commonly used as a means of displaying menu selections in restaurants. Frequently, the signs used for menu items at fast-food restaurants do not have sufficient space to advertise all of the special menu items and combinations offered at a restaurant at any given time. These tend to be stationary signs that do not change. Furthermore, the effort needed to change out the signage makes it somewhat prohibitive to change the signage on a regular basis. Use of this limited menu display space could be maximized if the signage could be changed between meal periods to display a different set of menu selections at different meal times. But it will be appreciated that this would require a system that would allow the signage to be easily changed. Other signs that allow individual menu items to be easily changed, such as that disclosed in U.S. Pat. No. 4,367,604, to Porter et al., allow for only a limited number of menu selections.

U.S. Pat. No. 5,016,371 to Aiken discloses a scrolling sign. These signs do not easily provide for changing of the advertisements or the introduction and deletion of selected menu items in the case of scrolling restaurant menus, and they tend to be expensive and bulky.

Devices in which advertising messages are placed on a flexible backing such as an endless film or sheet on supporting and return rollers are also known. One of the rollers is generally driven to move the flexible backing and repeatedly advance the messages to at least one window for display. Again, however, these devices have been difficult to use because it has been hard to change the endless film in order to change the advertisements when periodic change is desired. Furthermore, backlighting is generally not provided.

The present invention relates generally to a continuous advertising medium display device or apparatus for presenting changeable signage, and more particularly concerns a device that displays a continuous advertising medium similar to the endless film or sheet described above, however, the signage on the continuous medium can be installed or changed out inexpensively and efficiently by the owner or the owner's employees. No special training is required and it only requires the attention of the owner or the employee for a short period of time. It provides a convenient method for changing the information that is displayed on the continuous medium whenever change is desired, and it permits particular arrays of information displayed in the display device to change continually or to be selected for display or for concealment at any given time.

It will be appreciated from the foregoing that there is a real and long felt need for new mechanisms for conveniently providing changeable advertising, and that such systems will advance the field of public advertising throughout the world.

### SUMMARY OF THE INVENTION

Accordingly, it is an object of the present invention to provide an advertising display device for displaying a continuous advertising medium. The present advertising display device includes a tracking apparatus preferably providing an adjustable track for engagement of the continuous advertising medium, the tracking apparatus including a frame operatively connected with first and second rollers defining opposite ends of the adjustable track; the adjustable track having an operative configuration, a non-operative configuration and an adjustable track length; the adjustable track length being the distance between the most distal point on each of the respective rollers. One of the first and second rollers is a drive roller that provides a motive force that rotates the continuous advertising medium about the adjustable track when the continuous advertising medium is engaged with the adjustable track and it is in the operative configuration. In addition, one of the first and second rollers is a tension roller that is adjustably connected to the frame, wherein the tension roller has first and second positions with respect to the frame and the tension roller can be adjusted so that it is in either of the first and second positions. The adjustable track is in the operative configuration when the tension roller in the first position and it is in the non-operative configuration when the tension roller is in the second position; wherein the adjustable track length has a first length when the tension roller in the first position and a second length when the tension roller is in the second position and the first length is greater that the second length. The tracking apparatus also includes at least one light source preferably attached to the frame and positioned such that it is positioned between the first and second rollers and positioned in a manner in which the continuous advertising medium rotates around the light source when the continuous advertising medium is engaged with adjustable track, wherein light transmitted from the at least one light source backlights at least one of the series of adjacent advertising displays without passing through more than one thickness of the continuous advertising medium. The continuous advertising medium is preferably made of materials through which light can pass and the continuous advertising medium display device preferably includes a light source positioned to backlight a single thickness of the continuous advertising medium.

In certain embodiments, the advertising display device includes a housing and the tracking apparatus is pivotally interconnected with the housing. Preferably, the housing has an enclosure body and an enclosure door and the enclosure door is pivotally interconnected with the enclosure body such that the enclosure door can pivot open so as to permit easy access to the pivotally attached tracking apparatus so that-the housing provides an enclosure which can be easily opened by opening the pivotal enclosure door to permit access to the tracking apparatus. In other preferred embodiments, the frame has a front and a back, the front being closer to a display opening in the enclosure door than the back when the enclosure door is closed and the light source is positioned such that it is more removed from the front of the frame than from the back and the distance from the light source to the continuous advertising medium most proximate the enclosure door is greater than the distance from the light source to a portion of the continuous advertising medium most proximate the back of the frame. In still other preferred embodiments, the display device includes a sensor that senses movement and the drive roller has a drive actuator that causes the drive roller to provide motive force to rotate the continuous advertising medium about the adjustable track when the sensor senses motion. In yet other preferred embodiments, the display device includes a sensor that senses a predetermined event, the drive roller has a drive actuator that causes the drive roller to provide motive force to rotate the continuous advertising medium about the adjustable track when the sensor senses the predetermined event.

In alternate preferred embodiments, the advertising display device is a vending machine, a wall mounted display device and/or a free-standing pedestal display device.

It is an object of the present invention to provide an advertising display device for displaying a continuous advertising medium, which moves when predetermined events occur; one which is well lit from behind the preferably translucent continuous advertising medium in a manner in which the light is well diffused and yet bright enough to provide a bright eye-catching advertising display.

It is a further object of the present invention to provide a continuous advertising medium display device or apparatus that will allow continuous advertising mediums to be displayed with ease; easily installed, easily removed, and easily changed out, while also providing a simple method to provide changing advertising in which the graphics can be rotated at any given time to display a series of advertisements.

It is yet another object of the present invention to provide a continuous advertising medium display device that displays advertisements on a continuous advertising medium which rotates around a continuous track including lighting which back lights the continuous advertising medium, preferably an adjustable track.

A further object of the present invention is to provide a continuous advertising medium display device or apparatus that offers an easily changeable continuous medium, but which generally fits into the space provided by existing back-lit sign frames.

A further object is to provide a continuous advertising medium display device or apparatus that can be fitted into an existing vertical or tilted sign frame designed for use with or in place of signs that do not move or change.

Yet another object is to provide a continuous advertising medium display device or apparatus that is relatively light-weight and inexpensive, with a minimum of parts for easy manufacture, installation and maintenance, yet is attractive and reliable.

Other objects and advantages of the invention will become apparent upon reading the following detailed description and upon reference to the drawings. Accordingly, it will be appreciated that there remains a need for an easily changeable advertising display device that provides a bright and eye-catching medium for the display of a series of different advertisements. The present invention provides such a device and also provides other advantages over the prior art and solves other problems associated therewith.

### BRIEF DESCRIPTION OF DRAWINGS

In the drawings, in which like reference numerals and letters indicate corresponding parts throughout the several views,

FIG. 1 is a prospective view of a vending machine, which is a preferred embodiment of the continuous advertising medium display device 4 of the present invention, the preferred display device showing the continuous advertising medium 8 and elements of the electronic controls schematically in phantom;

FIG. 2 is a prospective view of the preferred display device 4 shown in FIG. 1, but showing the display device in an open configuration;

FIG. 3 is a prospective view of the preferred display device 4 shown in FIG. 1, but showing the display device in an open configuration and a tracking apparatus 10 engaged with a continuous advertising medium 8 pivoted away from an open enclosure door;

FIG. 4A is a prospective view similar to that shown in FIG. 3, except that the continuous advertising medium 8 is shown in phantom so that the various parts of the tracking apparatus 10 can be seen;

FIG. 4B is a prospective view similar to FIG. 4A except that a lever 22 which actuates tension cylinders 30 engaged with a tension roller 16 is actuated so that the tension roller is in a non-operative position, the distance between the two rollers is less than the distance between the respective rollers when the tension roller is in an operative position and the continuous advertising medium 8 can be easily removed and re-engaged as is indicated by the arrows on the illustration of the continuous advertising medium A which is shown disengaged from the tracking apparatus 10 and shown in phantom;

FIG. 5 is an enlarged view from the line 5-5 of FIG. 3 showing a hinge 26, which connects the tracking apparatus 10 to the door of the preferred display device 4;

FIG. 6 is a schematic representation of the electronic control system for the tracking apparatus 10;

FIGS. 7A-7C are partially broken away, enlarged prospective views similar to those shown in FIG. 3 showing a similar portion of the tracking apparatus 10 and the tension roller 16 and a portion of the spring bias tension cylinder in phantom in a series of staged illustrations showing the lever 22 moving the tension roller 16 from an engaged and operative position shown in FIG. 7A, through an intermediate position, shown in FIG. 7B, to an unengaged, non-operative position shown in FIG. 7C where the lever draws the tension roller 10 into the non-operative position;

FIG. 8 is a prospective view of an alternate continuous advertising medium display device 4′ consistent with that shown in FIG. 8 but showing the tension roller 16′ and the tracking apparatus in a non-operative configuration and the continuous advertising medium disengaged from the adjustable track and partially broken away to show elements of the electronic control system for the tracking apparatus 10′;

FIG. 9 is a prospective view similar to that shown in FIG. 8, but showing a further alternate embodiment of the continuous advertising medium display device 4″ similar to that shown in FIG. 8 but having the tension roller relocated to the lower part of the tracking apparatus 10″;

FIG. 10 is a perspective view of a further alternate embodiment of the present continuous advertising display device 4′″ showing elements of the tracking apparatus 10′″ and the continuous advertising medium 8′″ in phantom;

FIG. 11 is a perspective view of a preferred embodiment similar to the alternate display device 4″″ shown in FIGS. 8-9, but having new improvements and refinements which are preferred over related features of the embodiment shown in FIGS. 8-9;

FIG. 12 is a perspective view of the tracking apparatus 10″″ removed from the enclosure 6″″ in FIG. 11;

FIG. 13 is a further perspective view of the preferred tracking apparatus 10″″ shown in FIGS. 11 and 12;

FIG. 14 is an expanded view of the detail partially encircled by dashed arcuate line 14-14 of FIG. 13;

FIG. 15 is an expanded view of the detail partially encircled by dashed arcuate line 15-15 of FIG. 13;

FIG. 16 is a partial perspective view of the reverse side of the alternate embodiment of the display device 4″″ shown in FIG. 11, except that the enclosure 6″″ is partially broken away to show only the enclosure door 24″″ and a portion of the enclosure body 23″″ to which the door 24″″ is hinged, so that a photo sensor 86 attached to the back of the tracking apparatus 10″″ is shown;

FIG. 17 is a is a plan view of sheet material 92 on which advertising or other information or images is printed prior to joining the sheet material together to form a continuous advertising medium which can engage the tracking apparatus within the display device of the present invention;

FIG. 18 is a perspective view of a preferred continuous advertising medium 91a of the present invention in which an upper portion 92a of the sheet material 92 is placed over a lower portion 92b (shown in phantom) of the opposite end of the sheet material and the bottom surface of this upper portion is sealed to an upper surface of the lower portion creating an overlap to provide a strong seal between the respective opposite ends of the sheet material so that the ends of the sheet material are bound together to form the continuous medium;

FIG. 19 is a perspective view of an alternate continuous advertising medium 91b in which the sheet material 92, which makes up the continuous advertising medium is joined end-to-end by a transparent adhesive tape 93, which joins the respective ends of the sheet material;

FIG. 20 is a schematic representation of a sheet of sheet material 92 similar to that shown in FIG. 17 on which a continuous advertisement, intended to run continuously around the tracking apparatus, is printed prior to joining the sheet material end-to-end, as shown in FIG. 19;

FIG. 21 is a schematic plan of view of a sheet of sheet material 92″ containing two large ads, Ad 1 (94a) and Ad 2 (94b), respectively, and two smaller ads, 95a and 95b;

FIG. 22 is a perspective view similar to that in FIG. 22, but showing a continuous advertising medium 91c made from a sheet of sheet material 92″ similar to that shown in FIG. 24, which has a plurality of openings 88 in the sheet material proximate an edge 90 of the continuous advertising medium, through which light may pass;

FIG. 23 is a schematic plan view of a sheet of sheet material 92′″ on which a series of ads are printed, which has a plurality of openings 88 in the sheet material;

FIG. 24 is a schematic plan view of a sheet material 92″″ similar to that in FIGS. 21 and 23, except that there are five consecutive ads and five consecutive openings 88;

FIG. 25 is a schematic plan view of a sheet of sheet material 92′″″ similar to that in FIG. 27, except that there are seven consecutive ads placed on the sheet material and seven consecutive openings 88;

FIG. 26 is a schematic plan view of a sheet of sheet material 92″″″ similar to FIG. 24, except that there are two different ads placed on each of five consecutive ad panels, but only five consecutive openings 88;

FIG. 27 is a perspective view of a continuous advertising medium 91d similar to that shown in FIG. 18, except that the continuous advertising medium has a plurality of openings 88 in the sheet material proximate an edge of the continuous advertising medium in order to facilitate the passage of light from the photo sensor 86 shown in FIG. 16; and

FIG. 28 is an electrical diagram for the embodiment shown in FIGS. 11-16.

### DETAILED DESCRIPTION OF THE PREFERRED EMBODIMENT

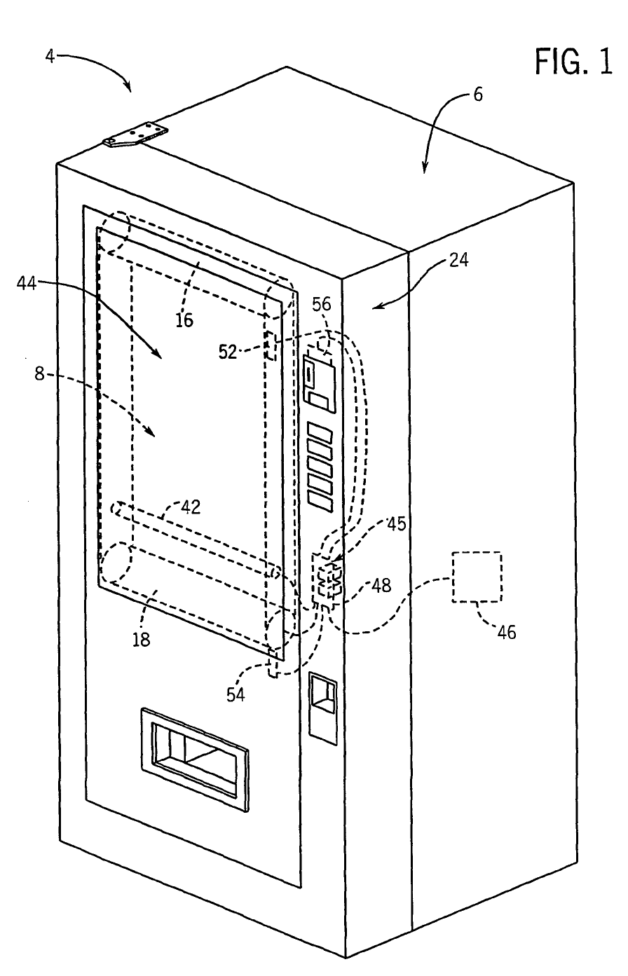

Referring now to the drawings, and to the FIG. 1 in particular, a preferred prototype of the continuous advertising display device 4 is shown. The display device 4 is a vending machine for canned beverages; however, it will be appreciated that the present invention can have other embodiments in which it is simply an enclosure 6 for a tracking apparatus 10 upon which a continuous advertising medium 8 is engaged for movement around the tracking apparatus 10. In other embodiments (not shown) the present invention may be a vending machine for products other than beverages and may also have other configurations, so long as the essential elements include a tracking apparatus 10 with which the continuous advertising medium 8 can be engaged for rotational movement around the tracking apparatus 10.

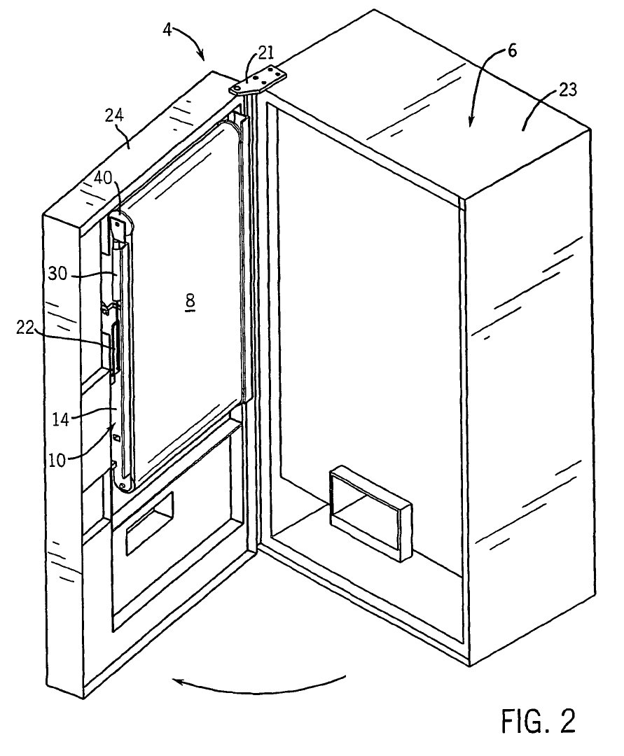

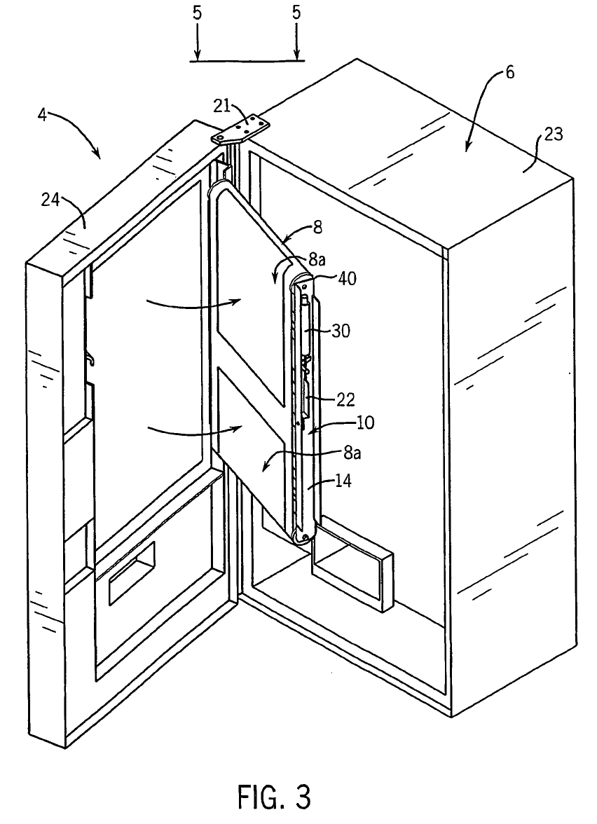

Referring now also to FIGS. 2-5, the continuous advertising medium display device 4 shown in FIGS. 1-5 includes a tracking apparatus 10 with which the continuous advertising medium 8 can be engaged. The tracking apparatus 10 provides an adjustable track 12 for engagement of the continuous advertising medium 8. The tracking apparatus 10 includes a frame 14 operatively connected with the first and second rollers 16, 18, respectively, which define opposite ends of the adjustable track 12. In the embodiment shown in FIGS. 1-5, the first roller 16 is the tension roller and the second roller 18 is a drive roller. It will be appreciated, however, that the first roller 16 could be a stationary roller, which is not adjustable and is not therefore a tension roller and that it would not need to be a drive roller either. Furthermore, the first roller 16 could be a tension roller and a drive roller, as it is only necessary that the present tracking apparatus 10 have one roller which acts to provide a motive of force which can drive the continuous advertising medium 8. In preferred embodiments, the tracking apparatus 10 will include a tension roller or a roller, which is adjustable so that the distance between the two rollers can be modified so as to decrease the length of the adjustable track 12. This allows the continuous advertising medium 8 to be easily removed from the tracking apparatus 10 when the length of the adjustable track 12 is shortened to make it a simple matter to remove the continuous advertising medium 8 from the adjustable track 12 and to replace the continuous advertising medium 8 with a new medium having different advertisements from the original continuous advertising medium 8. In this way, the present invention provides an easily changeable advertising display device 4 in which continuous advertising mediums having differing advertisements may be easily interchanged with minimal expertise and with a minimal amount of time and energy being involved in the process of changing the continuous advertising medium 8. Certain preferred embodiments also include drive rollers as mentioned above. As stated above, the tension roller can be the drive roller, but it is preferable to make the stationary roller the drive roller.

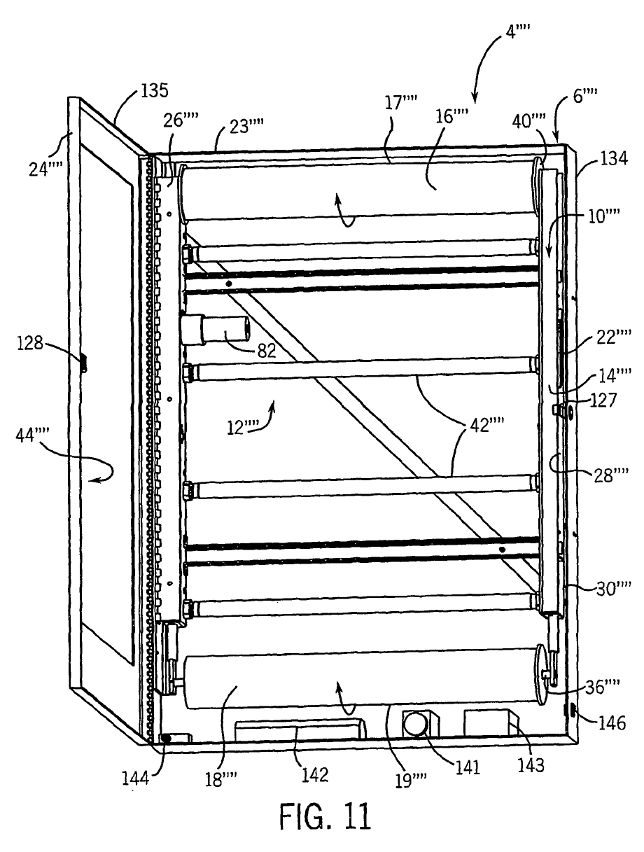

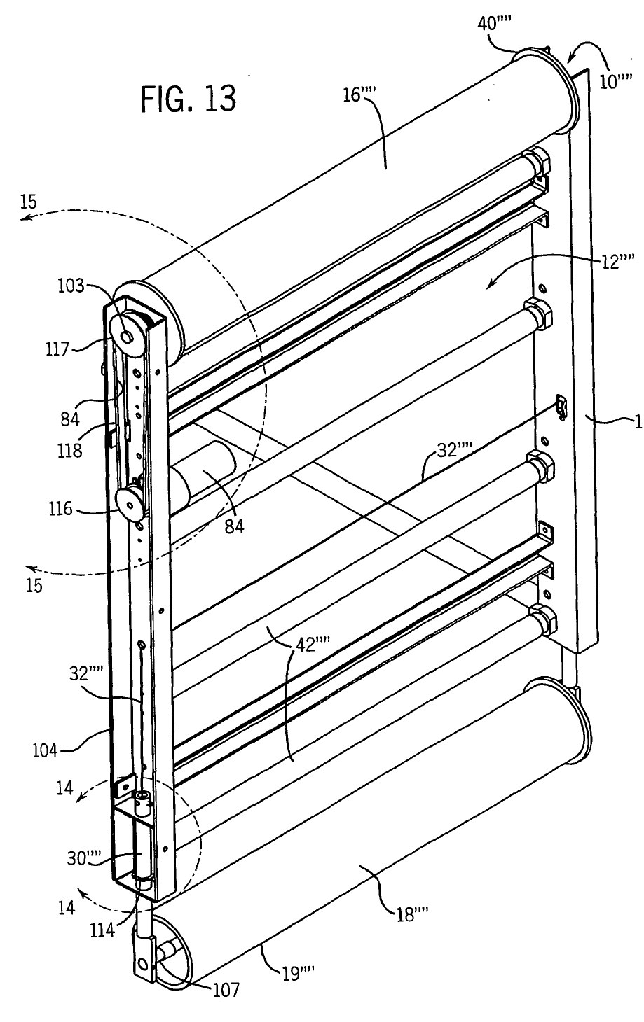

In the embodiment shown in FIGS. 1-5, the drive roller is the second roller 18 and it 5 has an internal drive motor 25 (shown in phantom). In an updated embodiment shown in FIGS. 11-16 and discussed further below, the upper roller 16″″ corresponding to the first roller 16 shown in FIGS. 1-5, is the drive roller and it is stationary. The tension roller is the lower roller 18″″ corresponding to the second roller 18. In addition, the drive roller is driven by a gear motor 82 and does not have an internal engine. The gear motor 82 is operatively connected with the drive roller 16″″ by a timing belt 84 or gear belt 118. It will be appreciated, therefore, the any reference in the present application to a drive roller is a reference to a roller that drives or causes the continuous advertising medium 8 to move around the adjustable track 12, 12′, 12″, 12′″, 12″″. Such a drive roller can have its own internal drive engine or it can be driven by an external mechanism.

In the embodiment shown in FIGS. 1-5, the tension roller 16 includes track guides 40 that help to guide the continuous advertising medium 8 and perhaps keep the continuous advertising medium 8 centered on the track 12. It will be appreciated that both rollers 16, 18 may have track guides 40 similar to those described above, but that it is not required to have any at all. The track guides 40, while not required, are helpful to prevent the edges of continuous medium 8 from traveling from one side of the respective rollers toward the other side and are generally preferred for that reason.

In the particular tracking apparatus 10 shown in FIGS. 1-5, the first roller 16 is a tension roller by virtue of the fact that it is interconnected with the frame 12 by a pair of tension cylinders 30 on opposite sides of the frame 14. The tension cylinders are just one of many elements which could be used to enable the adjustable track 12 to have an adjustable length which permits the continuous advertising medium to be easily removed when the length of the adjustable track is shortened. The tension cylinders 30 act in concert to spring bias the adjustable tension roller 16 upward.

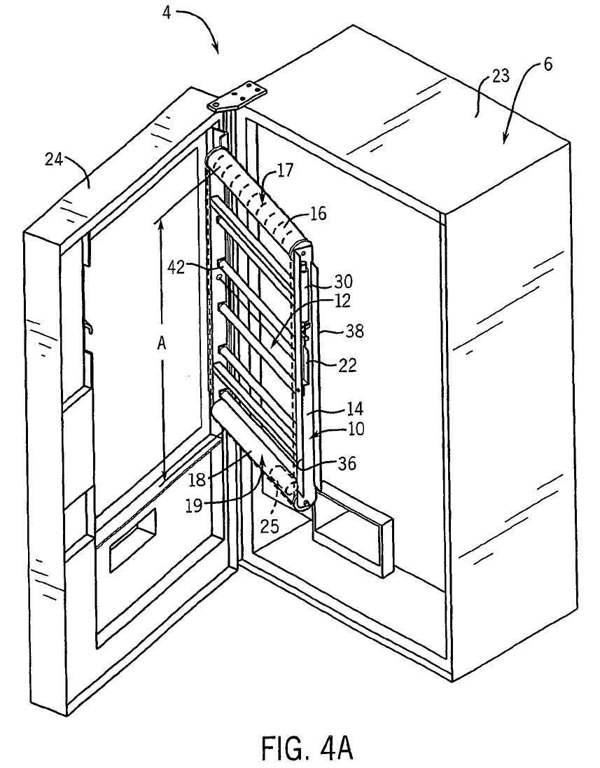

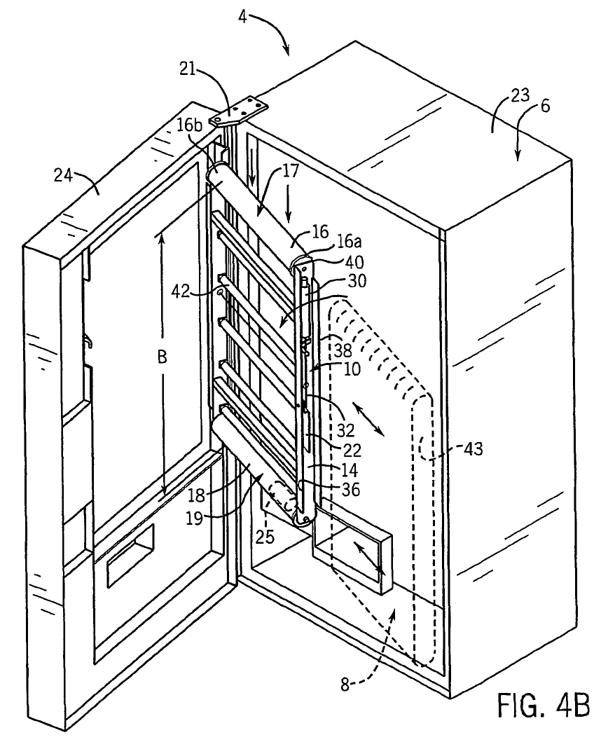

The second roller 18 in the preferred embodiment shown in FIGS. 1-5, is a drive roller or, in this particular embodiment, a power roller having an internal drive motor 25, preferably a DC gear motor, which can drive or turn the continuous advertising medium 8 when the advertising medium 8 is engaged with the drive roller 18 and the adjustable track 12 is in an operative configuration as shown in FIGS. 2, 3 and 4A. In this operative configuration, the first and second rollers, 16, 18, in this particular case the tension roller and the drive roller, respectively, are at a maximum distance from one another wherein the adjustable track is as long as it can be when engaged with the continuous advertising medium 8. As shown in FIG. 4A, the operative length A of the adjustable track 12 is the distance between places on respective surfaces of the respective rollers which are most distal or most removed from one another along a line that is generally parallel to the track 12 when the adjustable track is in the operative configuration. As shown in FIG. 4B, the length of the adjustable track can be shortened to a non-operative length B which is the distance between such places on respective surfaces of the respective rollers which are most distal or removed from each other when the adjustable track 12 is in the non-operative configuration and the first roller 16, in this case the tension roller, is adjusted to be closer to the other roller to enable the continuous advertising medium 8 to be easily removed from the tracking apparatus 10 or engaged or reengaged with the tracking apparatus 10 when it is separated from the tracking apparatus 10.

In this particular embodiment, the tracking apparatus 10 includes the first and second rollers 16, 18, which are operatively interconnected with the frame 14 proximate opposite ends 17, 19 of the frame 14, so that they can rotate with respect to the frame 14. The tension roller 16 is interconnected with tension cylinders 30 which are spring-biased away from the opposite end 19 of the frame 14 where the other roller 18 is engaged. Cables 32 are preferably secured at one end to the respective tension cylinders 30 on each side of the frame 14 and secured at the opposite end to a lever 22, which is designed to provide sufficient leverage to compress the springs 34 within each of the tension cylinders 30, when the lever 22 is turned to the compressed position shown in FIG. 4B, so as to draw the tension roller 16 closer to the second roller 18. It will be appreciated that any mechanism for adjusting the position of the tension roller, whether well known in the art or otherwise, may be used to adjust the position of the tension roller so as to reduce or shorten the length of the adjustable track and enable the continuous advertising medium 8 to be either removed when engaged or engaged when unengaged. Furthermore, it will be appreciated that the tension roller 16, as stated above, may very well be a drive roller in alternate embodiments of the present invention. It is not believed that there is any limitation on the function of the respective rollers in either regard, except it was believed at one time that there may be some slight mechanical advantage to placing the drive roller in a position in which the continuous advertising medium 8 is drawn down onto the upper portion of the drive roller by gravity and also that there may be some mechanical advantage to having a tension roller of the type shown in this embodiment where the tension roller is in a lower position in which the tension of the springs forces the tension roller down against the continuous advertising medium. There is no intention, however, to limit the present invention to one in which these are the only mechanisms used either to drive the continuous advertising medium or to adjust the tension roller. Furthermore, it will be appreciated that the adjustable track of alternate embodiments of the present invention (not shown) may provide a configuration in which the adjustable track runs horizontally so that neither the first or second roller is in an upper or lower position as shown in the preferred embodiments described herein. In these alternate embodiments, it is believed that there will be a mechanical advantage to providing a greater tension against the continuous advertising medium and that tracking guides 40, of the type shown on the tension roller 16 referenced in FIGS. 2, 3 and 4B, help to channel the CAM 8 and keep it on the adjustable track. Track guides 40 may very well be necessary on both rollers to successfully track the continuous advertising medium along the adjustable track for an extended period of operation. It should also be appreciated, however, that when certain rigid sheet materials are used to make continuous advertising mediums, tracking problems are generally reduced and can be eliminated.

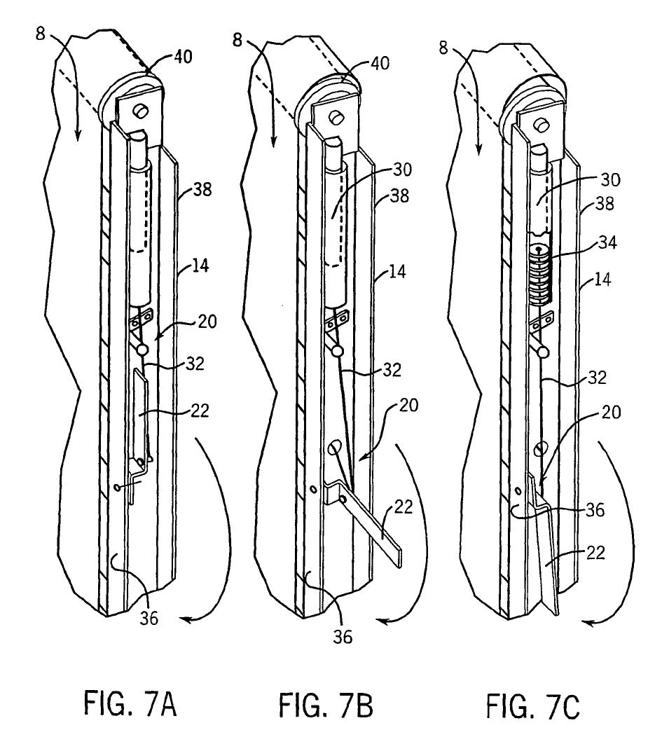

Referring now specifically to FIGS. 4A and B and to FIGS. 7A, 7B and 7C, the adjustable track 12 is adjusted from the operative configuration as shown in FIG. 4A to the non-operative configuration shown in FIG. 4B by adjusting a lever 22 which draws cables 32 which compresses the respective spring-bias tension cylinders 30 which are operatively engaged with each end 16a, 16b of the tension roller 16 to reach the non-operative configuration shown in FIG. 48. The continuous advertising medium 8 is easily removed from the tracking apparatus 10 when the adjustable track 12 is in this configuration. It will be appreciated that any untrained individual can easily manipulate the lever 22 and ascertain that the continuous advertising medium 8 can be easily removed by lifting the continuing advertising medium over the tracking guide 40 on the near side of the tension roller 16, and then sliding the continuous advertising medium 8 off of the adjustable track 12. It will be further appreciated that it will be just as easy for such an untrained individual to ascertain how to put the continuous advertising medium 8 or an alternate continuous advertising medium back onto the adjustable track 12 through some rather simple and straightforward deduction and/or trial and error. Once the continuous advertising medium 8 is re-engaged with the tracking apparatus 10 when it is in the non-operative configuration shown in FIG. 413, the lever 22 can be adjusted again to release the spring biased tension cylinders 30 to expand the length of the track 12, thereby adjusting the position of the tension roller 16 so that a tension is placed on the inside surface 43 of the continuous advertising medium 8 and the adjustable track 12 assumes the operative configuration shown in FIG. 4A.

Referring now particularly to FIGS. 4A and 4B, the tracking apparatus 10 including the frame 14 and the first and second rollers 16, 18, a source of light, preferably a series of fluorescent lights, 42, are also provided by the tracking apparatus 10. The lights 42 are preferably interconnected with a ballast 43 and a power source 46 by a circuit 48. In preferred embodiments, such as those shown, the fluorescent lights 42 are carefully positioned within the tracking apparatus 10 so that the continuous advertising medium 8 will encircle the lights 42 when the continuous advertising medium 8 is engaged on the track 12. Although the track 12 need not necessarily be adjustable, the preferred track 12 is adjustable. In certain preferred embodiments, the frame 14 will have a front 36 and a back 38 and the lights 42 or any alternate light source (not shown) will be closer to the back 38 of the frame 14 and tracking apparatus 10 than toward the front 36 so that the light from the light source 42 will diffuse more before it strikes the back or the inside surface 43 of the continuous advertising medium 8 in the front of the enclosure 6 where the backlit continuous advertising medium 8 can be viewed through a display opening 44. As seen in FIGS. 4A and 4B, the fluorescent lights 42 are further removed from the front 36 of the tracking apparatus 10 than they are from the back 38 of the tracking apparatus 10. This preferred positioning is believed to permit the light to diffuse best so that the backlit continuous advertising medium 8 will be illuminated and show as well as possible to the public through the display window or display opening 44.

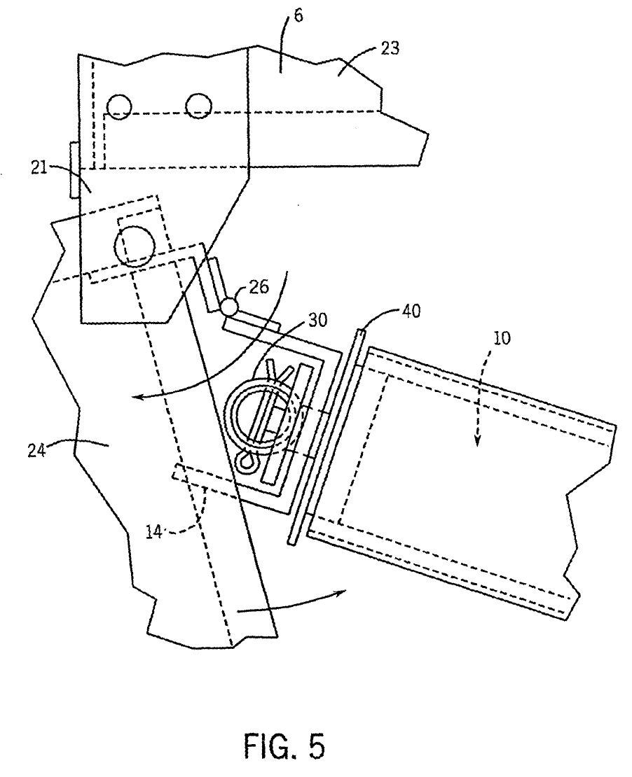

Referring now also to FIG. 5, the enclosure 6 includes an enclosure door 24 and an enclosure body 23 pivotally attached to one another by a pair of brackets 21 on the top and the bottom (not shown) of the enclosure in the manner in which refrigerator doors and refrigerator bodies are commonly pivotally connected. The tracking apparatus 10 is pivotally connected to an enclosure door 24 by a hinge 26. This enables the housing or enclosure 6 of the preferred continuous advertising medium display device 4 to be opened and further allows the tracking apparatus 10 to swing away from the enclosure door 24. It will be appreciated, however, that the tracking apparatus 10 may take any configuration and need not in fact have an enclosure. Furthermore, the tracking apparatus may be enclosed within an alternate housing (not shown), which simply allows the alternate tracking apparatus (not shown) to telescope out of the enclosure on a pair of telescoping securing arms (not shown) operatively attached to opposite ends of the alternate tracking apparatus (not shown) without pivoting with respect to an enclosure door of the type shown in the preferred embodiments of the present invention. The important characteristic involved is that the tracking apparatus 10 is easily accessible so that the adjustment mechanism 20 may be actuated and the adjustable track 12 can be easily adjusted between the operative configuration an the non-operative configuration.

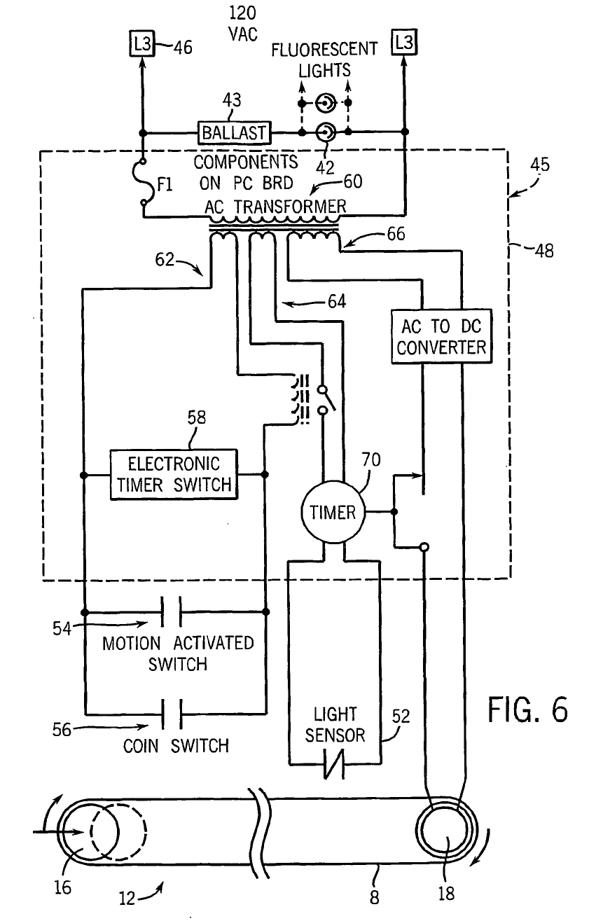

Referring now also to FIG. 6 and particularly to FIGS. 1 and 6, the continuous advertising medium display device 4 includes electronic controls 45, which drive the second roller 18, which is a power roller, provide power for the lights 42 and operate an electrical circuit 48. In certain preferred embodiments, the second roller 18 is a direct current (DC) power roller, which drives or turns the continuous advertising medium 8. The power roller preferably has an internal motor and gears and the dimensions are preferably in a range from about 1.9 to about 4 inches, although other size dimensions may be used. It will also be appreciated that other power rollers can be used and that they may run on either alternating current (AC) or direct current (DC). Preferred power rollers include power rollers from the following manufacturers: Sparks, Icon Co., Inter Roll, Power Roller, Weston, Itoh Denki and the like, preferably Itoh Denki, USA, Incorporated, Wilkes-Barre, Pa. Although power rollers are preferred, a drive roller having a separate drive mechanism (not shown) can also be used in alternate embodiments (not shown).

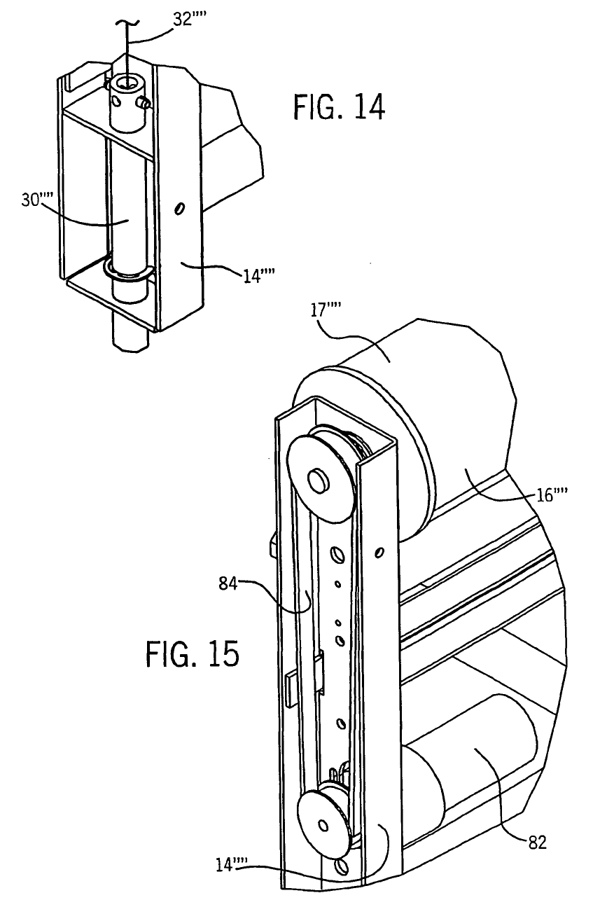

In the preferred display device 4 shown in FIG. 14B, the power roller receives power from a power source 46. The power then travels through a circuit 48 similar to that shown in FIG. 6 in which the power to the power roller (second roller 18) may be interrupted by an electronic timer switch 50, a light sensor 52, a motion-activated switch 54, a coin switch 56 or a timer/sensor relay switch 58. The preferred circuitry allows the continuous advertising medium 8 to rotate or turn along the adjustable track 12 when the continuous advertising medium (CAM) 8 is engaged with the tracking apparatus 10, when the tracking apparatus 10 is in the operative configuration as shown in FIG. 4A When the continuous advertising medium 8 turns or rotates about the adjustable track 12, the continuous advertising medium 8, which has a series or a plurality of adjacent advertising displays, allows different adjacent advertising displays 8a, 8b to be displayed through the display opening 44 in the enclosure door 24 of the enclosure 6. The circuit 48 shown in FIG. 6 allows the continuous advertising medium 8 to move so that one advertising display or another, or a combination thereof, will be shown. The continuous advertising medium 8 can be rotated in response to motion detected by a motion activated switch 54, the receipt of a coin through a coin switch 56 or other events detected in alternate embodiments of the present invention. The motion may also be timed so that the continuous advertising medium 8 will rotate for a period of time, then stop, then resume rotating and then stop again in a series of stop and start events, which can be predetermined in a manner gauged to meet promotional needs and desires. In addition, the continuous advertising medium 8 may have a dark spot 73 (see as shown in phantom in FIG. 20) placed on the sheet material, which makes up the continuous advertising medium, in a predetermined location, which is detected by the light sensor 52. The dark spot 73 can be placed on the back or inside surface 43 of the continuous advertising medium 8. The light sensor 52 is preferably placed between the rollers 16, 18, so that it can sense a change of light on the back of the continuous advertising medium 8. The light sensor 52 will be positioned close to the continuous advertising medium 8 so as to detect the darkness on the continuous advertising medium 8 when the dark spot 73 rotates around to the position where the light sensor 52 is located. The use of this light sensor 52, in combination with the timer 70, will allow the continuous advertising medium 8 to rotate for any portion of one full cycle until the light sensor 52 detects the change in light associated with the presence of the dark spot 73 or any other dark spot, which will switch the circuit off, stopping the power roller 18. It will be appreciated that there may be a plurality of dark spots (now shown), which are interspersed along the back of the CAM 8, and which cause the CAM 8 to stop rotating at predetermined places so that certain segments of the CAM 8 are displayed through the display window 44, when the CAM 8 is stationary between timed movements. The timer 70 will activate the circuit 48 again to drive the power roller (second roller 18) until the power roller (second roller 18) is stopped again by a further break in the circuit 48 caused by the detection of the change in light by the light sensor 52, when another black spot comes to a position proximate the light sensor 52. Similarly, the motion-activated switch 54 will cause the circuit 48 to close, activating the power roller 18 until the power roller (second roller 18) is switched off, preferably by the presence of a dark spot proximate the light sensor 52, which will open the circuit 48 and turn the power roller 18 off until further motion is detected by the motion-activated switch 54. Similarly, the coin switch 56 may be substituted for the motion-activated switch 54 or the two may be maintained in parallel so that either may close the circuit 48 and initiate movement of the continuous advertising medium 8 as driven by the power roller 18. It will be appreciated that any circuit which is switched on and off in any of a variety of ways may be used in alternate embodiments of the present invention and that the motion of the continuous advertising medium 8 may also be completely continuous without any circuit breakers other than the simple act of supplying power. For example, a metallic member or a magnetic member may be used in place of the dark spot 73 and a proximity sensor may be used in place of the light sensor 52, either a proximity sensor that will detect the proximity of metallic members or a sensor that will detect the proximity of a magnetic member, either of which are available from various industry sources.

The wiring for the preferred display device 4 shown in FIG. 6, is constantly hot-wired with 120 volts of alternating current, although a fuse (not shown) may also be provided for protection. The circuit 48 also powers the fluorescent lights 42 and a power transformer 60 that steps down to three separate circuits 62, 64 and 66.

Through the alternating current (AC) voltage transformer 60, voltage is constantly supplied to the three independent circuits 62, 64 and 66. The first low voltage supply circuit 62 initializes all succeeding motions of the power roller (second roller 18). This circuit 62 includes three switching elements; the motion activated switch 54 that senses motion outside of the display device 4 and is mounted on the front of the enclosure 6, preferably just inside the display opening 44; the coin switch 56, which is connected and parallel to the motion-activated switch 54 and an electronic timer 58 which is also connected and parallel. The coin switch 56 detects a coin or coins (not shown) passing through an existing pathway for electronic current. The electronic timer 58 is preferably a digitized timer that switches to a closed state at a particular period of time so as to close the switch and move the timer when a specific period of time has elapsed. In this way, in absence of any motion detection by the motion activated switch 54 and the absence of the detection of a coin passing into the vending machine by the coin switch 56, the continuous advertising medium will eventually turn so that different advertising displays are displayed through the display opening 44. The power from this control circuit 62 will close a relay 68 thereby activating a specialized timer sensor relay 70 in the second circuit 64. Activation of the timer sensor controlled circuit 64 closes the third circuit 66, permitting power to flow to the power roller (second roller 18) to drive or turn the continuous advertising medium 8 so that it will rotate about the adjustable track 12. The third circuit 66, that is opened and closed by the timer sensor control or relay 70, preferably has a slightly larger amperage supply than is primarily used for the power of the continuous advertising medium driver motor or power roller (second roller 18). Depending on the power roller selected, alternate circuits may either power an alternating current power roller, that receives power directly from the transformer, or a direct current power roller that receives power from the AC to DC converter or AC transformer 60. The activation of the timer/sensor relay 70 and the power roller (second roller 18), drives the continuous advertising medium 8 around the adjustable track 12. In the preferred embodiment shown in FIGS. 1-6, the power roller 18 is a direct current power roller. In preferred embodiments, the continuous advertising medium 8 can have a series of black marks (not shown) along an edge designed and constructed to rotate to predetermined positions proximate the light sensor 52 so as to create a change in the light detected by the light sensor 52. This mark or, preferably a series of marks, will each break the circuit 48 and cause the continuous advertising medium 8 to stop rotating when these marks separately come into close proximity with the light sensor 52. In these embodiments, the motion of the continuous advertising medium 8 will stop when darkness is detected by the light sensor 52 when each of these marks come into close proximity with the light sensor 52, assuming the circuit 48 is designed to stop under these circumstances.

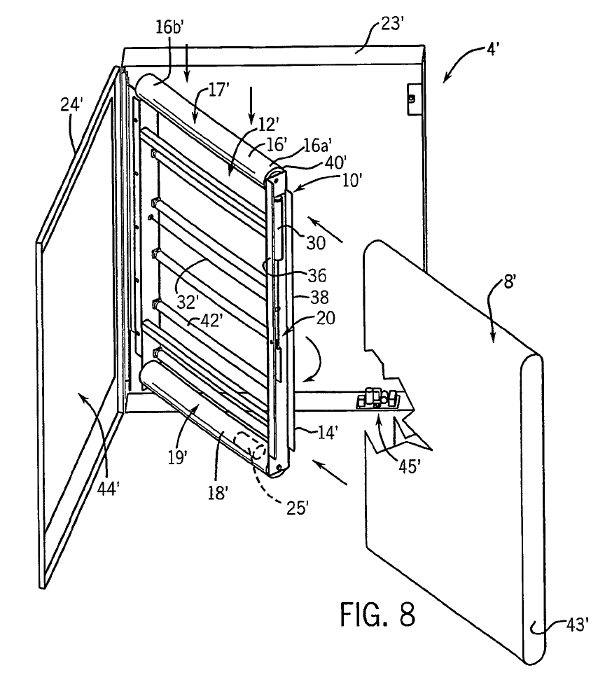

Referring now to FIG. 8, a simplified continuous advertising medium display device 4′ is shown in which the tracking apparatus 10′ is pivotally attached to a housing or enclosure 6′ which includes an enclosure body 23′, an enclosure door 24′ and a display opening 44′. The simplified display device 6′ is designed for attachment to a wall (not shown) or other structure, perhaps including a pedestal (not shown) of one kind or another. It may have a circuit 48′ controlling movement of the continuous advertising medium 8′ in a manner similar to that described above for the preferred display device 4 shown in FIGS. 1-6. The tracking apparatus 10′ of the alternate embodiment shown in FIGS. 8-10 is generally the same as the tracking apparatus 10 of the preferred embodiment described above except that there is no coin switch as the device has no coin receiving opening.

In a further alternate embodiment, shown in FIG. 9, the tension roller is switched to the bottom of the tracking apparatus 10″ (second roller 18″) and the power roller or drive roller (first roller 16″) is located on the top of the tracking apparatus 10″.

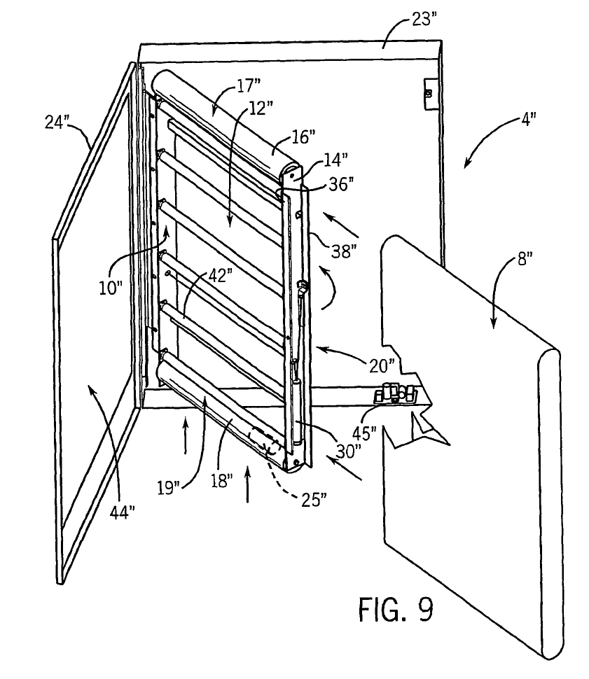

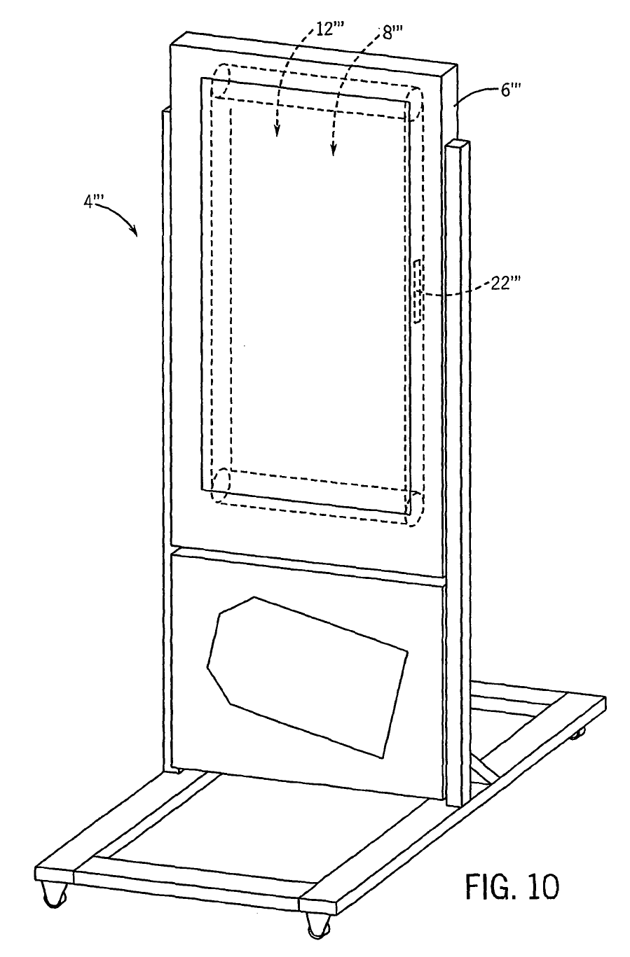

Referring now also to FIG. 10, a further configuration of the present continuous advertising medium display device 4′″ is shown. This device is intended to stand alone in open areas and requires no support from other objects. It will be appreciated that power for any of the embodiments described above may be provided by batteries (not shown) in situations where access to power is limited. In such situations, batteries of any kind sufficient to drive the power roller may be used. In the alternative, it will also be possible to use energy generating sources which create electric energy from alternative energy sources such as light, chemical reaction, cooling, heating, wind and the like, to replenish or provide energy to such batteries or directly act as the power source for the device.

The continuous advertising medium (CAM) 8 of the present invention is generally made from sheet material, that is joined together at opposite ends to form a continuous sheet. The sheet material that is generally used can be any sheet material upon which advertisements can be printed. These sheet materials preferably include paper, vinyl, polyester or the like, preferably reinforced paper such as fiber reinforced paper, fiber reinforced vinyl and the like. Preferred sheet materials include materials which are easily backlit such as for instance the following products: Backlit Uniflex PL1 from Hanwh; Soi-line Backlit from Sioen; Backlit light F4598 from Forbo; product no. 552-771 from Ferrari Backlit Vinyl; Backlit 8220 from Seaman; Backlit from Kobond; product no. 830GPS from 3M Panaflex; Coolflex 80 from Cooley Backlit; Multipurpose Flexface (MPF) or MFP Backlit from Signtech and the like; preferably product no. 830GPS from 3M Panaflex; Coolflex 80 from Cooley Backlit; and MFP Backlit from Signtech. The preferred sheet material will be one which is UL listed for sign cabinets containing lighting and/or electrical junctions or electrical fixtures. Other preferred characteristics include a heavier weight material, material which effectively diffuses light and consistently provides the best medium for printing; a material in which the scrim is preferably less apparent or close to being visible or is entirely invisible or nonexistent. MFP or Signtech Flexface from Signtech is a flexible, reinforced, modified protective coated polyvinyl material designed for backlit applications with digital or heat transfers printing and was at one time a generally more preferred sheet material.

In preferred embodiments, the sheet material 92, used to make CAMs 8, 91a-91d, will preferably provide the following physical properties. They will be flexible enough to roll up but rigid enough to track properly on the adjustable track, between our tracking guides that are on the rollers on the frame. The flexibility of the material gives the CAM the ability to go around adjustable track without having. It needs to be flexible enough to roll up, rigid enough to track on the adjustable track, between the tracking guides, assuming they are provided, and yet it has to be soft enough so that the material does not have a strong memory, so that after it is rolled up, or goes around our adjustable track, it doesn't maintain that shape. The CAM has to be able to be taut without holding a shape with its memory, so those two properties are important. It also has to be substantially inelastic so that it doesn't stretch perceptibly. It is possible to allow some stretching, because of the nature of the tensioning system provided by the preferred adjustable track, which can adapt to a little stretching, but stretching limits the quality of the printing if the sheet material stretches over an eighth of an inch. In preferred embodiments, the sheet material also needs to be material, which accepts suitable inks, as well.

In preferred embodiments, the sheet material 92, used to make CAMs 8, 91a-91d, will provide the following physical properties. They will be flexible enough to roll up but rigid enough to track properly on the adjustable track, between our tracking guides that are on the rollers on the frame. The flexibility of the material gives the CAM the ability to go around adjustable track without having. It needs to be flexible enough to roll up, rigid enough to track on the adjustable track, between the tracking guides, assuming they are provided, and yet it has to be soft enough so that the material does not have a strong memory, so that after it is rolled up, or goes around our adjustable track, it doesn't maintain that shape. The CAM has to be able to be taut without holding a shape with its memory, so those two properties are important. It also has to be substantially inelastic so that it doesn't stretch perceptibly. It is possible to allow some stretching, because of the nature of the tensioning system provided by the preferred adjustable track, which can adapt to a little stretching, but stretching limits the quality of the printing if the sheet material stretches over an eighth of an inch. In preferred embodiments, the sheet material also needs to be material, which accepts suitable inks, as well.

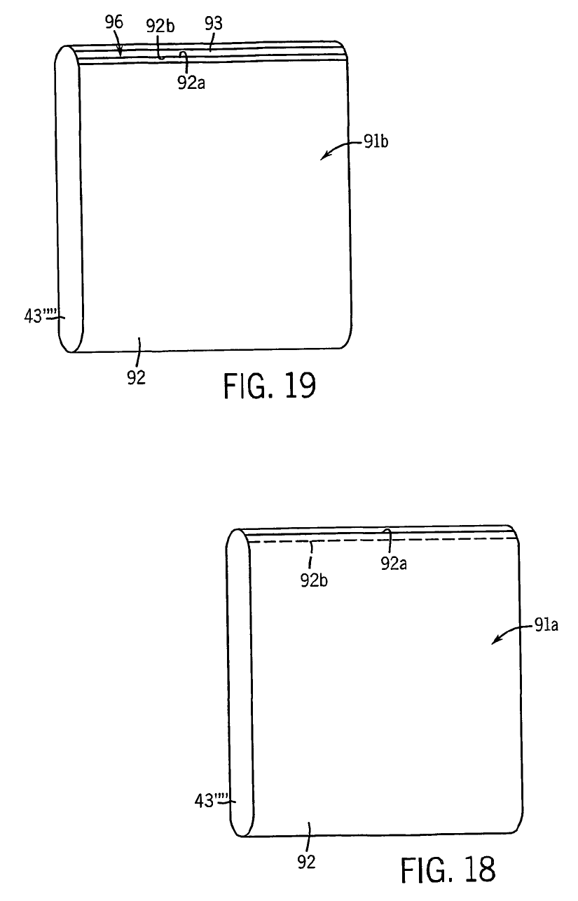

The sheet material will preferably provide a medium that has sufficient rigidity to track properly and it needs to be rigid in parallel with the rollers; in other words, if the rollers create a vertical track you want the medium to be horizontally rigid so that it will track in one embodiment anyway a drive roller that has guide washers but may not have a tension roller down below that has any guide washers on it. Then it also has to be relatively non-elastic; we don't want it to stretch over time, because that would make it ineffective for holding advertising. Also we want it to have low memory so that as it turns and maybe stops at a certain place, we don't want it to remember that it is bent in a certain way over the top of the roller. Also, it needs to be flexible so that it can bend and then return to a flat section as it rolls down the track. Now, two other things it needs to do. It needs to be fire-resistant so that it can be Underwriter's Laboratory (UL) approved for most applications, although it wouldn't be required in all situations perhaps. Paper is a good example of something that is horizontally rigid on a vertical track and also has low memory, is flexible enough to go over a roller and is relatively non-elastic. Obviously paper tears, perhaps too easily, to be an effective medium, but something that didn't tear easily and was good at accepting suitable inks would be good. The sheet material must also be a medium that can be backlit, so it must be, to a certain degree, translucent and allow light to flow through. Obviously, paper would be at least somewhat translucent, but not probably as much as would be preferred in certain preferred embodiments. There are a number of ways to print on the medium, including digital printing, electrostatic printing, silk screening, various photographic processes and the like. However, in preferred embodiments either digital or photographic printing is employed. Some of the materials used for digital printing are backlit materials such as Arlon-Signtech MFP, manufactured by Signtech in San Antonio, Tex.; Ultralon IV (15 ounce backlit material) manufactured by Ultraflex, Rockaway, N.J.; Staffitex 5505, available from Stafford Textiles Ltd., Toronto, Ontario; Nurflex Backlit Light, product no. 11032, available from Nur Media Solutions, San Antonio, Tex.; Nurflex Backlit FR, product no. 10532, available from Nur Media Solutions, San Antonio, Tex.; DMVLA 5-BLF, available from Sihl Distributors, manufactured by Rexam, Greater Massachusetts, and other products which have similar characteristics; especially the horizontal rigidity on a vertical track, the non-elasticity, the ability to be backlit, the low memory of the material, and the flexibility of the material, as well as its ability to receive ink. The preferred inks are translucent inks which are generally used in situations where there is a need to backlight the medium on which the inks are printed. There are many types of ink that are sold specifically for this purpose and these inks are well known in the art. They differ from opaque inks in that they are translucent and allow light to flow through and allow the colors of the translucent inks to become illuminated by lighting provided behind the medium upon which the inks are printed. In the manufacture of the continuous advertising mediums, the advertisements are printed onto the medium as a sheet of sheet material and then the ends of the sheet are bound together to form a loop, which is then a finished product, which can be placed on the adjustable track. The medium is alternatively sewn together, RF welded together, glued together, taped together with two-sided tape between an overlap between the respective ends or sealed end to end in some other way. In preferred embodiments, a two-sided adhesive tape from 3M Company, St. Paul, Minn., namely very high bond (VHB) tapes, are used to seal the ends of the sheet material together in the manner shown in FIG. 18, discussed below. In alternate embodiments, the images are printed digitally on the medium and the medium is then RF welded or sealed together using two-sided tape, which is relatively invisible to the eye, although it may be seen upon close examination.

The advertisements or other promotional materials are preferably printed on the preferred sheet material using a digital printing process, although it will be appreciated that any printing process can be used to print on the sheet material within the scope of the broadest aspects of the present invention. In preferred embodiments, a Nur Fresco piezo printer (360 DPI) is used to print on the preferred sheet material, although similar equipment from companies such as Vutech, Ariz., Matan, LAC, Scitex and the like, can be used. The inks are preferably solvent based, although it will be appreciated that any appropriate inks can be used. The preferred solvent based inks will preferably be translucent or transparent inks and have a UV stability of 18 months. In the most preferred embodiments, images are printed on the medium using one of two printing systems developed by Eastman Kodak Co., the DURATRANS® system or the DAY-NIGHT® system.

Once the advertisements are printed on the sheet material, the ends of the sheet material can be joined together. This is preferably achieved by sealing one end to the other in a manner that is predetermined and which can include any known sealing methods appropriate for the materials to be sealing. Sealing flexible plastic materials such as the preferred sheet materials is preferably accomplished by using a method creating a small overlap between the respective ends of the sheet material and the sealing of the adjacent surfaces together using techniques such as: Impulse sealing; Ultrasonic sealing; hot air sealing; radio frequency (RF), heat sealing or welding, also know as electronic or dielectric heat sealing, stitching, taping and the like. These techniques are now well known in the art.

Referring now also to FIGS. 11-16, a further preferred embodiment of the present display device 4″″ is shown. The display device 4″″, shown in FIG. 11, includes an enclosure 6″″ which is intended to qualify for a NEMA 4 rating for electrical cabinets which are intended to be used outdoors and in other harsh environmental conditions. The enclosure 6″″ has an enclosure door 24″″ pivotally attached to an enclosure body 23″″. A preferred tracking apparatus 10″″ is pivotally attached to the enclosure body 23″″ by a hinge 26″″. The tracking apparatus 10″″ includes a frame 14″″ including side panels 28″″ to which the first roller 16″″ at the upper end 17″″ of the adjustable track 12″″ is non-adjustably, pivotally secured and the second roller 18″″ at the lower end 19″″ of the adjustable track 12″″ is adjustably secured to the frame 14″″ by a pair of tension cylinders 30″″ similar to those described in the previously discussed embodiments. In this embodiment, however, the tension cylinders 30″″ provide a spring biasing assist to bias the second roller 18″″ downward to engage the continuous advertising medium (not shown) when the adjustable track 12″″ is in the expanded orientation shown in FIGS. 11-13. The adjustable track 12″″ may be reduced in a manner similar to that in which the adjustable track 12″″ shown in FIGS. 4A-4B and FIGS. 7A-7C is reduced, except that the tension roller or adjustable roller is, in this case, the second roller 18″″ at the lower end 19″″ of the adjustable track 12″″. In order to reduce the adjustable length of the adjustable track 12″″, the lever 22″″ is lifted in the manner shown in FIGS. 7A-7B in relation to the prior embodiment, thus drawing the cables upward against the spring biasing effect of the tension cylinders 30″″, thereby raising the second roller 18″″ at the lower end 19″″ of the adjustable track 12″″. This will enable one to easily slide a continuous advertising medium (not shown) onto the adjustable track 12″″ of this embodiment of the present invention.

The further embodiment shown in FIGS. 11-16 differs from the embodiment shown in FIG. 8 in numerous ways, although it is somewhat more similar to the embodiment shown in FIG. 11 in that the tension roller is in fact at the lower end 19″″ of the adjustable track 12″″. The embodiment shown in FIGS. 11-16 has different side panels 134, 28″″ which provide channels in which the tension cylinders 30″″ and the cables 32″″ interconnected with the lever 22″″ reside. These preferred side panels 28″″ are made by bending a flat sheet of aluminum over a bar and stamping holes into the aluminum sheet, rather than purchasing prefabricated side panels, as was previously done. In a preferred embodiment, the aluminum sheet is preferably 12-gauge aluminum, which is approximately 105/1000's of an inch thick. In other embodiments, 10-gauge or 14-gauge may be used, however using a lighter gauge aluminum than that may result in structural weakness and using any heavier gauge would increase the cost of the device. The enclosure door 135, 24″″ is latched in a closed position, when the cam lock 127 engages the door latch 128. A latch pin 125 is engaged with the side panel 134 to hold the pivotal frame 14″″ in place within the enclosure body 23″″.

In the embodiment shown in FIGS. 11-16, the upper roller 16″″ is, essentially, a driven roller rather than a drive roller. In experiments with the earlier prototypes, sufficient precision for certain applications was not obtained using the light sensor 52 in the electric circuit 48. Therefore, the drive rollers of the prior embodiment were replaced with a first roller 16″″ which is driven by a direct current (DC) gear driven motor drive 82 which drives a timing belt 84 or gear belt 118 which drives the first roller 16″″.

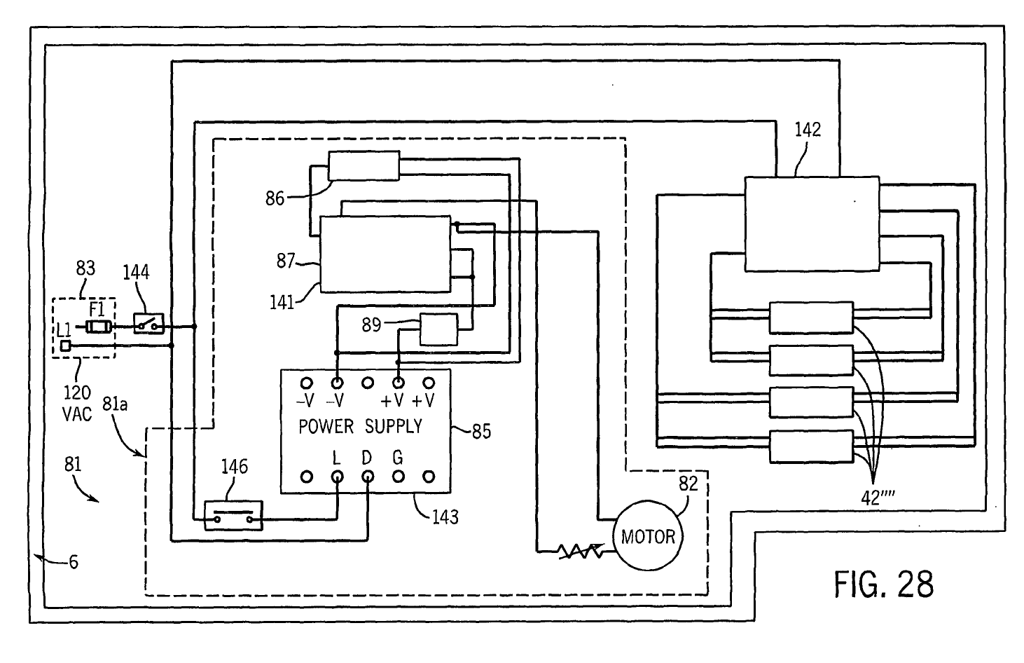

Referring now also to FIG. 28, this system allows the driven roller 16″″ to stop with greater precision. The motor 82 is preferably either a 12 or a 24-volt DC electric gear driven motor, preferably a Pitman GM 9,000 Series 24 volt gear motor manufactured and distributed by Pitman, Harleysville, Pa. In the most preferred embodiments, a Hanson Corporation 24 volt motor wound to provide a driven speed of 60 rpms is used. The new embodiment also includes a circuit 81 that utilizes 120-volt alternating current from a standard wall socket 83, which is turned on and off by a door switch or limit switch 144, that is only closed when the door 135, 24″″ is closed. The power supply 83 is used to provide power to the lights 42″″ and also supplies power to a secondary circuit 81a including a transformer or power supply 85 or 143 that steps the power down from 120 volts to, preferably, 24 volts for the gear motor and also converts the electricity from alternating current to direct current.

The power is run through a time-off timer 87, 141, which controls power to the electric drive motor 82, which drives the driven roller 16″″ at the top of the adjustable track 12″″. The circuit also includes a sensor 86, preferably an Omron photo micro-sensor, model no. EE-SX670 from Braas & Company distributors. The electricity in the circuit 81a runs to the sensor 86 so that upon the completion of a photo beam circuit the timer 87 is tripped and power to the DC motor is cut-off and the belt-driven roller 16″″ will stop with sufficient precision to allow for repetitive movement of the continuous advertising medium (not shown). The transformer 85, 143 is preferably an Omron S82K-01512 power supply which is a 24-volt power supply that is used in alternate embodiments. The circuit 81a also includes a power switch 146.

In the time-off circuit, the power is always on, driving the DC gear motor and the drive roller except when the timer switches the circuit off for, however, long a duration for which the timer is set. It could be anywhere from one to two seconds to 20 seconds, or for whatever time for which the timer is set; then it will turn the power back on and leave it on until the sensor gets switched again. The photo sensor 86 is positioned so that a continuous advertising medium of the type discussed below in relation to FIGS. 21-27, which include openings 88 proximate an edge of the continuous advertising medium 91a, 91b, 91c, 91d, which is coordinated with the photo sensor 86 so that the openings 88 allow a photo beam (not shown) from the photo sensor 86 to complete a photo circuit when it passes through the openings 88 which trip the switch and shut off the electricity to the DC gear motor 82. When the photo sensor connection is made, the photo beam in the photo sensor 86 completes the circuit and stops the electricity coming through the timer from the transformer on its way to the gear motor. In the preferred embodiment, the timer is a 24-volt timer from Omron Corporation, model no. H3CR-A timer. In the preferred embodiments shown in the circuit diagram in FIG. 28, the secondary circuit 81a includes a rheostat 89 or a potentiometer that allows the voltage of the direct current going through the timer 87 to the gear motor 82 to be either stepped up or stepped down to either speed up or slow down the gear motor 82, as well as the driven roller, in this case the upper roller 16″″. In production models of the present display device, the transformer 85, 143 may be a 12-volt transformer and the gear motor 82 may be a 12-volt gear motor. In these production models, it is likely that the rheostat will be eliminated.

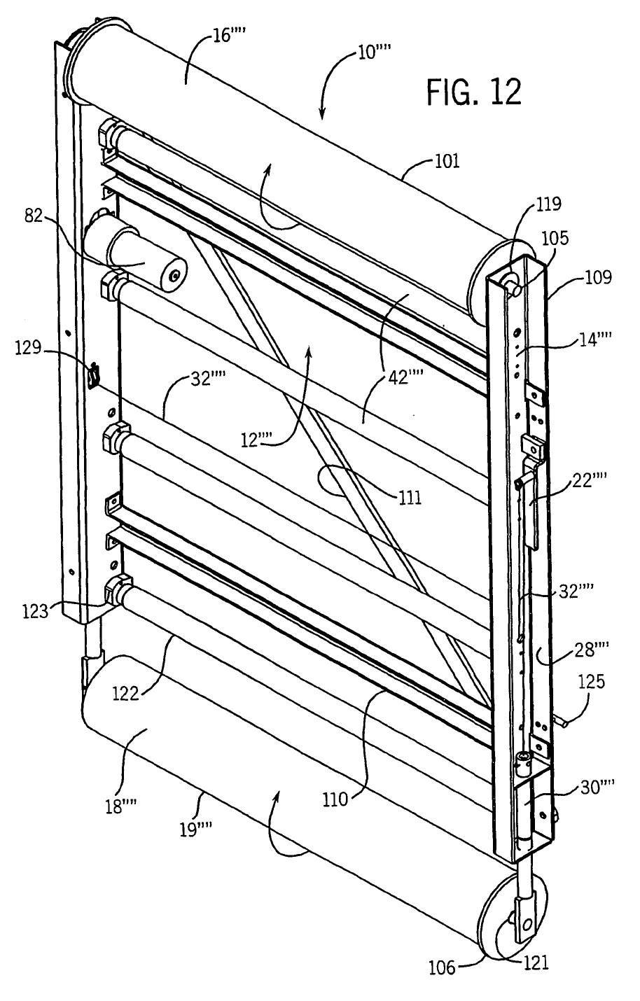

As mentioned above, the enclosure 6″″ of the embodiment shown in FIG. 12 is intended to have a sufficient NEMA rating to be acceptable for outdoor use, preferably a NEMA 4 rating. The requirements for such an enclosure are well known in the art. They include, among other things, suitable insulation and minimal airflow from the outside to the inside of the enclosure which is maintained by using appropriate gaskets across and around the doors and the like. A circuit breaker is also provided on the cabinet door so that the power is immediately cut if the door is opened or if there is a ground fault which drains electricity from the power source. In preferred embodiments, the enclosure will also include a lock (not shown) for security purposes. In the embodiment shown in FIGS. 12-16, the tension roller 18″″ independently floats on the respective tension cylinders 30″″ and can also slide a small distance, preferably from a 1/4 of an inch to an inch, more preferably from about 3/8 of an inch to 3/4 of an inch along the axel 36″″. This flexibility or tolerance reduces wear on the belt and reduces stress on the DC gear motor as well and allows a larger margin for error in creating suitable continuous advertising media for the adjustable track 12″″. It is believed that there is significant advantage in allowing the tension roller 18″″ to slide back and forth to some limited degree about the axel 36″″ at the same time that the respective ends of the second roller 18″″ float independently with respect to the frame 14″″ because each of the tension cylinders 30″″compress or expand independent of one another.

The preferred frame 4″″, shown in FIGS. 11-16, also includes side frames 109 joined together by cross frames 110, stabilized by a stabilizing strap 111. The upper roller 16″″ has a roller surface 101 and is secured to the frame 4″″ by a shaft 105 and a bearing flange 119. The lower roller 18″″ includes a hub idler 106 and is secured to the frame 4″″ by a shaft (not shown) passing through a sleeve bearing 121. Fluorescent light bulbs 42″″, 122 are held in lamp holders 123. The cable 32″″ travels the far side of the frame 4″″ via a pulley 129.

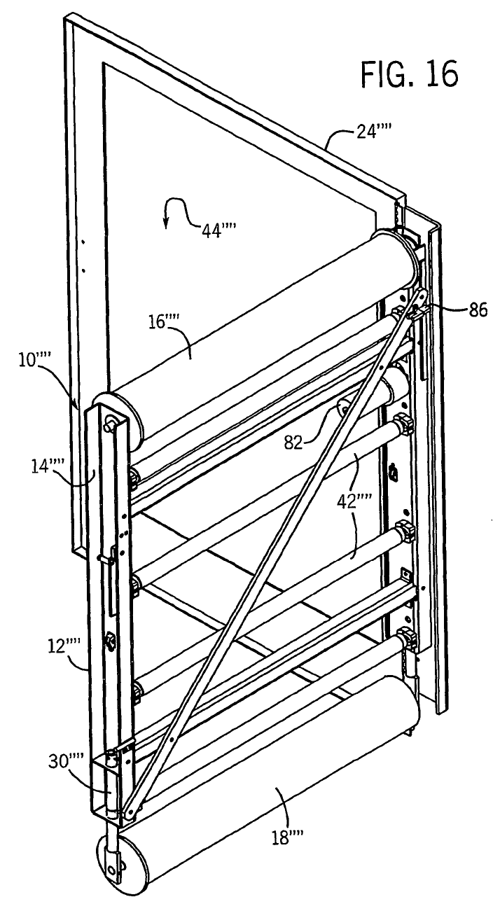

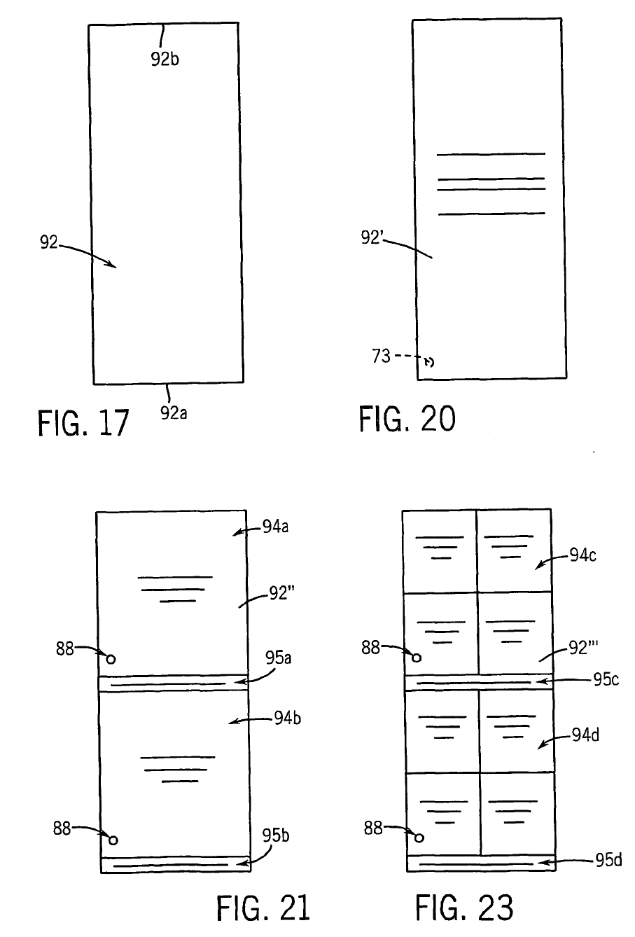

Referring now also to FIGS. 17-27, a rectangular sheet of sheet material 92 is used to make a continuous advertising medium 91a, 91b as shown in FIGS. 18 and 19. In order to create the continuous advertising medium (CAM) 91a shown in FIG. 18, the lower end of 92a of the sheet of sheet material 92 is overlapped over the upper end 92b of the sheet material 92 and the abutting surfaces of the respective ends are sealed together using a number of processes, including RF welding, adhesive sealing, heat sealing and the like. It will be appreciated that either end may overlap the other end and that there is no particular advantage either way. It is also possible to secure the opposite ends 92a, 92b of the sheet of sheet material 92 together by placing an adhesive material over the top of the seam between the respective ends in the manner shown in FIG. 19, where a transparent adhesive tape 93 secures the respective ends 92a, 92b of the sheet material 92 together leaving a seam 96 between the respective ends 92a, 92b. Referring now specifically to FIG. 17, a sheet is generally rectangular and the length of the sheet is determined in order to allow sufficient overlap for sealing the sheet and creating a loop, which has the desired length. Referring now specifically to FIG. 18, when the sheet material is sealed together, end-to-end, it will form a loop and will have a desired length depending on the application. It will be appreciated that a loop may be rotated on a track which is vertical so that the advertising will appear at the bottom and rise to the top of the vertical display panel and then loop to the backside of the track before it comes around to the front of the display panel again. In alternate embodiments, it may be that there will be reason to have the advertisements flow from the back over the roller at the top of the vertical track so that the advertisements are moving downward on the vertical display as the track turns the continuous advertising medium. It will also be appreciated that in other alternate embodiments, the track will not be vertical but may be horizontal in which case, the continuous advertising medium can be designed to provide advertisements which move either from left to right or from right to left. In further embodiments, in which the track is neither vertical nor horizontal, it may be possible to provide continuous advertising mediums, which allow the advertisements to flow in either direction along the track.

In FIG. 20, a schematic plan view is provided of a sheet of sheet material 92″″ in which a continuous advertising message can be provided. This sheet 92″″ can be used to make a CAM of the kind shown in either FIG. 18 or 19. A dark spot 73 is provided on the back side of the sheet 92′ which can cause a light sensor 52′ of the type described in relation to the prior embodiments, to break the circuit and stop the motion of the drive roller and the CAM 92′.

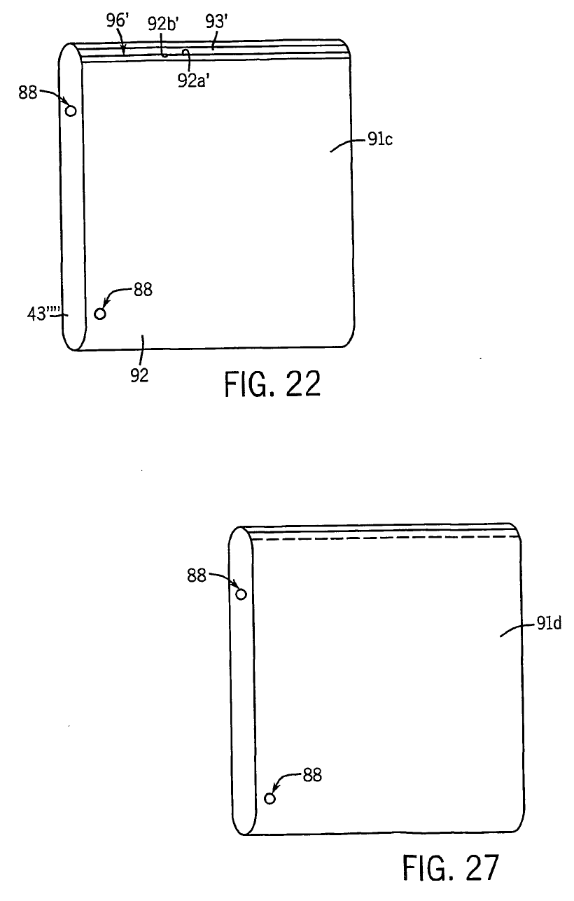

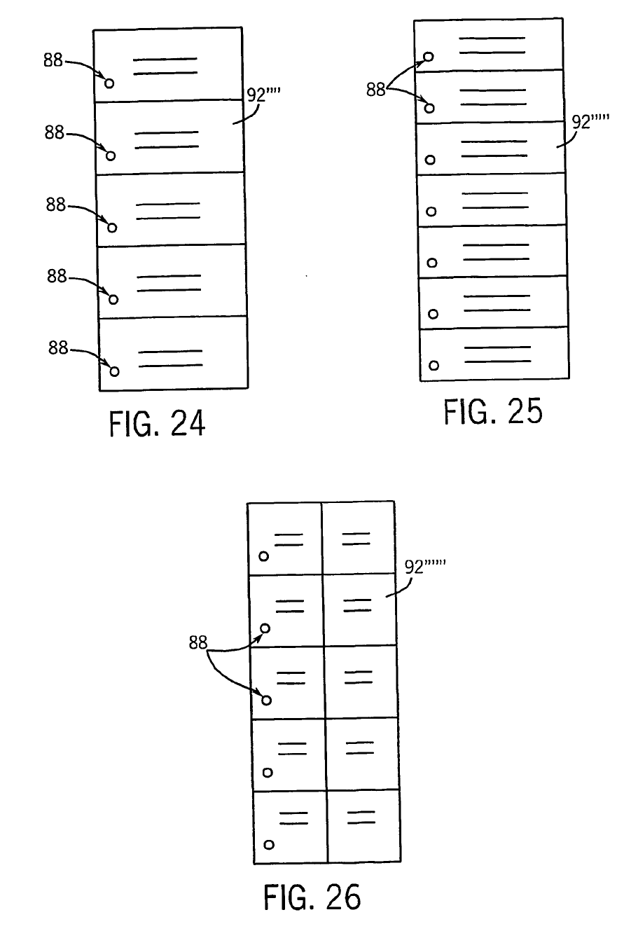

In FIG. 21, a sheet of sheet material 92″ is shown schematically to provide two large ads 94a and 94b and two smaller ads 95a and 95b, which, when the sheet 92″ is joined together, end-to-end, to form a CAM 91c similar to that shown in FIG. 22, the openings 88 caused the CAM 91c to stop when the smaller ads 95a, 95b are positioned at the upper and lower extremities of the adjustable track, when the CAM 91c is used in a display device 4″″ of the type shown in FIGS. 11-16, because the openings 88 are coordinated to allow light to pass from one part of the photo sensor to another part of the photo sensor 86 to complete the photo circuit and stop the flow of electricity to the DC gear driven motor 82 and the driven roller, in this case the upper roller 16″″. In this way, the smaller ads 95a, 95b are only seen in motion through the display window 44″″ and are not visible through the display window 44″″ when they are stationary at any time, thus providing a place for certain advertising material, the image of which must be viewed by a person (not shown) observing the advertisements provided on the CAM 92c, while this advertising material is in motion. This provides advertisers with opportunities to seek an observer's attention with information that cannot be easily obtained without a somewhat more concentrated effort to capture the image and make a mental impression of the image as it is moving. It will be appreciated that this somewhat more challenging task, requires a somewhat different memory making or memory capturing event for the observer and offers advertisers opportunities to require the observer to pay closer attention to the images, if the observer wishes to complete a memory capturing event suitable to successfully remember the information provided by such a moving image. This offers advertisers an opportunity they would not otherwise have. A similar but somewhat different format is provided by the schematic sheet 92′″ shown in FIG. 23 that also includes smaller ads 95c and 95d which are only seen in motion while the larger ad spaces 94c and 94d are split up into four separate boxes for four separate ads or images, any of which will be stationary and viewable through the display window 44″″ at one time or another, unlike the smaller ads 95c and 95d which will not be viewable through the display window 44″″ unless they are in motion. In FIGS. 24-26, a series of schematic plan views of additional sheets 92″″, 92′″″ and 92″″″ are shown, each having a somewhat different format and having light passing openings 88 associated with each of the separate ads, which enables the alternate display device 4″″ to stop a CAM made from each of these sheets 92″″, 92′″″ and 92″″″ when more than one of these larger ads is viewable through the display window 44″″. In the case of the sheet 92″″ shown in FIG. 24, the resulting CAM would allow two of the larger ads to be seen through the display window when the CAM is stationary. When the driven roller 16″″ turns the CAM, it would stop again when one new ad is displayed and one of the previously displayed ads is moved out of the display window 44″ ″. When the driven roller 16″″ moves again, it would again come to a stop when one more ad is displayed and one of the previously displayed ads is removed from display. In this way, the ads will be shown sequentially in the display window with the ads immediately adjacent. In the schematic shown in FIG. 28, the sheet 92′″″ will result in a CAM which will allow three larger ads to be shown in the display window 44″″ of the alternate display device 4″″ when the CAM created from the sheet 92′″″ is stationary. As the belt moves, it will move upward on a vertical display device such as that shown in FIGS. 11-16 and will introduce new ads sequentially and remove ads from display in the display window 44″″ in a sequential manner as well, similar to the system for the sheet 92″″ shown in FIG. 24.

Similarly, the side-by-side ads shown in FIG. 26 will be shown sequentially in virtually the same manner as the larger ads shown in the sheet 92″″ shown in FIG. 24.

Referring now also to FIG. 27, it will be appreciated that the sheets 92″ and 92′″ shown in FIGS. 21 and 23, respectively, will create a CAM 91d like the CAM shown in FIG. 18 if the ends are overlapped as previously described. It will be appreciated that the descriptive word “advertisements”, when used in the present specification, may mean either (1) advertising material or (2) images having advertising value and/or content or not. It will also be appreciated that, in preferred embodiments, the advertisements will rotate on a vertical adjustable track 12″″, of the kind shown in FIGS. 11-16, in the manner in which the ads appear at the bottom of the display window 4″″ and then move upward. In alternative embodiments, the advertisements may move downward; however, it is believed that it would be preferred to rotate the ads upwards so that one could follow the ads by scrolling downward as is common practice. Similarly, a horizontally oriented adjustable track (not shown) would preferably introduce an advertisement and move it across the display window from right to left, although it is believed to be less certain that this is the preferred method of displaying moving advertisements on a continuous advertising medium of this type.

It is to be understood that even though numerous characteristics and advantages of the various embodiments in the present invention have been set forth in the foregoing description, together with details of the structure and function of various embodiments of the invention, this disclosure is illustrative only and changes may be made in detail, especially in matters of size, shape and arrangement of parts, within the principles of the present invention to the fullest extent indicated by the broad general meaning of the terms in which the appended claims are expressed.

What is claimed is:

1. An advertising display device for displaying a continuous advertising medium; the continuous advertising medium having a thickness and an exterior surface displaying a series of adjacent images; the advertising display device comprising:
a tracking apparatus having an adjustable track for engagement of the continuous advertising medium, the tracking apparatus including a frame operatively connected with first and second rollers defining opposite ends of the adjustable track; each roller having a roller surface, the adjustable track having an operative configuration, a non-operative configuration and an adjustable track length; the adjustable track length being a distance between a first point on the roller surface of the first roller most removed from the second roller and a second point on the roller surface of the second roller most removed from the first roller; one of the first and second rollers being a drive roller that provides a motive force that rotates the continuous advertising medium about the adjustable track when the continuous advertising medium is engaged with the adjustable track and the adjustable track is in the operative configuration; one of the first and second rollers being a tension roller that is adjustably connected to the frame; wherein the tension roller has first and second positions with respect to the frame and the tension roller can be adjusted so that it is in either of the first and second positions; the adjustable track being in the operative configuration when the tension roller is in the first position and in the non-operative configuration when the tension roller is in the second position; wherein the adjustable track length has a first length when the tension roller in the first position and a second length when the tension roller is in the second position; the first length being greater that the second length; the adjustable track having at least one source of light attached to the frame and positioned such that the at least one source of light is positioned between the first and second rollers in a manner in which the continuous advertising medium rotates around the light source when the continuous advertising medium is engaged with the adjustable track, wherein light transmitted from the at least one source of light backlights at least a portion of one of the series of adjacent images without passing through more than one thickness of the continuous advertising medium.

2. The advertising display device of claim 1, further comprising:
a housing; the tracking apparatus being pivotally interconnected with the housing.

3. The advertising display device of claim 2, the housing having an enclosure body and an enclosure door; the enclosure door being pivotally interconnected with the enclosure body such that the enclosure door can pivot open so as to permit easy access to the pivotally attached tracking apparatus; wherein the housing provides an enclosure for the tracking apparatus which can be opened by opening the pivotal enclosure door to permit access to the tracking apparatus.

4. The advertising display device of claim 2, the housing having an enclosure body and an enclosure door; the enclosure door having a display opening through which at least a portion of at least one of the series of adjacent images can be observed when the enclosure door is closed, the frame having a front and a back, the front being closer to the display opening than the back when the enclosure door is closed, the at least one source of light being positioned such that the at least one source of light is more removed from the front than from the back such that a first distance from the at least one source of light to a portion of the continuous advertising medium most proximate the enclosure door is greater than a second distance from the at least one source of light to a portion of the continuous advertising medium most proximate the back.

5. The advertising display device of claim 1, wherein the tracking apparatus further includes a tension roller actuating mechanism that adjusts the position of the tension roller from the first position to the second position and from the second position to the first position so that the adjustable track length changes from the first length to the second length and from the second length to the first length, respectively.

6. The advertising display device of claim 5, wherein the continuous advertising medium can be easily disengaged from the adjustable track when the tension roller actuating mechanism is actuated such that the tension roller goes from the first position to the second position and the adjustable track length is changed from a first length to a second length.

7. The advertising display device of claim 1, wherein at least one of the first and second rollers is a floating roller; wherein the floating roller has first and second ends, each of the respective first and second ends being independently spring biased such that the floating roller places out ward tension upon the continuous advertising medium when the adjustable track is in the operative configuration.

8. The advertising display device of claim 1, wherein at least one of the first and second rollers having a plurality of track guides, one each on opposite ends of the roller, which cooperate to retain the continuous advertising medium on the roller so that it stays on the adjustable track when the continuous advertising medium is engaged upon the adjustable track and the adjustable track is in the operative configuration.

9. The advertising display device of claim 1, further comprising:
a motion sensor that senses movement, the drive roller having a drive actuator that causes the drive roller to provide the motive force to rotate the continuous advertising medium about the adjustable track, the motion sensor being operatively interconnected with the drive actuator such that the drive actuator is actuated when the motion sensor senses motion.

10. The advertising display device of claim 1, further comprising: a sensor that senses a predetermined event, the drive roller having a drive actuator that causes the drive roller to provide the motive force to rotate the continuous advertising medium about the adjustable track, the sensor being operatively interconnected with the drive actuator such that the drive actuator is actuated when the sensor senses the predetermined event.

11. The advertising display device of claim 1, wherein the at least one source of light is a series of lights positioned such that the continuous advertising medium rotates around the series of lights.

12. A vending machine for displaying a continuous advertising medium; the continuous advertising medium having a thickness and an exterior surface displaying a series of adjacent images; the vending machine comprising:
a tracking apparatus having an adjustable track for engagement of the continuous advertising medium, the tracking apparatus including a frame operatively connected with first and second rollers defining opposite ends of the adjustable track; each roller having a roller surface, the adjustable track having an operative configuration, a non-operative configuration and an adjustable track length; the adjustable track length being a distance between a first point on the roller surface of the first roller most removed from the second roller and a second point on the roller surface of the second roller most removed from the first roller; one of the first and second rollers being a drive roller that provides a motive force that rotates the continuous advertising medium about the adjustable track when the continuous advertising medium is engaged with the adjustable track and the adjustable track is in the operative configuration; one of the first and second rollers being a tension roller that is adjustably connected to the frame; wherein the tension roller has first and second positions with respect to the frame and the tension roller can be adjusted so that it is in either of the first and second positions; the adjustable track being in the operative configuration when the tension roller is in the first position and in the non-operative configuration when the tension roller is in the second position; wherein the adjustable track length has a first length when the tension roller in the first position and a second length when the tension roller is in the second position; the first length being greater that the second length; the adjustable track having at least one source of light attached to the frame and positioned such that the at least one source of light is positioned between the first and second rollers in a manner in which the continuous advertising medium rotates around the light source when the continuous advertising medium is engaged with the adjustable track, wherein light transmitted from the at least one source of light backlights at least a portion of one of the series of adjacent images without passing through more than one thickness of the continuous advertising medium.

13. The vending machine of claim 12, further comprising:
a housing; the tracking apparatus being pivotally interconnected with the housing; the housing having an enclosure body and an enclosure door; the enclosure door being pivotally interconnected with the enclosure body such that the enclosure door can pivot open so as to allow easy access to the pivotally attached tracking apparatus; wherein the housing provides an enclosure for the tracking apparatus which can be opened by opening the pivotal enclosure door to permit access to the tracking apparatus.

14. The vending machine of claim 13, the housing having an enclosure body and an enclosure door; the enclosure door having a display opening through which at least a portion of at least one of the series of adjacent images can be observed when the enclosure door is closed, the frame having a front and a back, the front being closer to the display opening than the back when the enclosure door is closed, the at least one source of light being positioned such that the at least one source of light is more removed from the front than from the back such that a first distance from the at least one source of light to a portion of the continuous advertising medium most proximate the enclosure door is greater than a second distance from the at least one source of light to a portion of the continuous advertising medium most proximate the back.

15. The vending machine of claim 12, wherein the tracking apparatus further includes a tension roller actuating mechanism that adjusts the position of the tension roller from the first position to the second position and from the second position to the first position so that the adjustable track length changes from the first length to the second length and from the second length to the first length, wherein the tension roller actuating mechanism can be actuated such that the tension roller goes from the first position to the second position so that the continuous advertising medium can be easily disengaged from the adjustable track.

16. The vending machine of claim 12, wherein at least one of the first and second rollers is a floating roller; wherein the floating roller has first and second ends, each of the respective first and second ends being independently spring biased such that the floating roller places out ward tension upon the continuous advertising medium when the adjustable track is in the operative configuration; and wherein at least one of the first and second rollers having a plurality of track guides, one each on opposite ends to the respective roller, which cooperate to retain the continuous advertising medium on the roller so that it stays on the adjustable track when the continuous advertising medium is engaged upon the adjustable track and the adjustable track is in the operative configuration.

17. The vending machine of claim 12, further comprising:
a sensor that senses movement, the drive roller having a drive actuator that causes the drive roller to provide the motive force to rotate the continuous advertising medium about the adjustable track, the sensor being operatively interconnected with the drive actuator such that the drive actuator is actuated when the sensor senses motion.

18. The vending machine of claim 12, further comprising:
a sensor that senses a predetermined event, the drive roller having a drive actuator that causes the drive roller to provide the motive force to rotate the continuous advertising medium about the adjustable track, the sensor being operatively interconnected with the drive actuator such that the drive actuator is actuated when the sensor senses the predetermined event; the sensor being a payment collection device that can detect the receipt of payment within the payment collection device; wherein the predetermined event is the receipt of payment within the payment collection device.

19. A method of displaying images, comprising the steps of:
providing an advertising display device for displaying a first continuous advertising medium; the continuous advertising medium having a thickness and a series of adjacent images; the advertising display device including a tracking apparatus and at least one source of light, the tracking apparatus providing an adjustable track for engagement of the continuous advertising medium, the tracking apparatus including a frame operatively connected with first and second rollers defining opposite ends of the adjustable track; each roller having a roller surface, the adjustable track having an operative configuration, a non-operative configuration and an adjustable track length; the adjustable track length being the distance between a first point on the roller surface of the first roller most removed from the second roller and a second point on the roller surface of the second roller most removed from the first roller; one of the first and second rollers being a drive roller that provides a motive force that rotates the continuous advertising medium about the adjustable track when the continuous advertising medium is engaged with the adjustable track and the adjustable track is in the operative configuration; one of the first and second rollers being a tension roller that is adjustably connected to the frame; wherein the tension roller has first and second positions with respect to the frame and the tension roller can be adjusted so that it is in either of the first and second positions; the adjustable track being in the operative configuration when the tension roller in the first position and in the non-operative configuration when the tension roller is in the second position; wherein the adjustable track length has a first length when the tension roller in the first position and a second length when the tension roller is in the second position; the first length being greater that the second length; the at least one source of light being attached to the frame and positioned such that the at least one source of light is positioned between the first and second rollers in a manner in which the continuous advertising medium rotates around the light source when the continuous advertising medium is engaged with adjustable track, wherein light transmitted from the at least one light source backlights at least a portion of at least one of the series of adjacent images without passing through more than one thickness of the continuous advertising medium;
placing the adjustable track in the non-operative configuration;
removing the first continuous advertising medium from the tracking apparatus; and
engaging a second continuous advertising medium upon the tracking apparatus and placing the adjustable track in the operative configuration.

20. The method of displaying images of claim 19, the advertising display device having a housing; the tracking apparatus being pivotally interconnected with the housing; the housing having an enclosure body and an enclosure door; the enclosure door being pivotally interconnected with the enclosure body such that the enclosure door can pivot to an open position so as to allow easy access to the pivotally attached tracking apparatus; wherein the housing provides an enclosure for the tracking apparatus which can be opened by opening the pivotal enclosure door to allow access to the tracking apparatus; the step of removing including opening the enclosure.

21. The method of displaying images of claim 20, wherein the tracking apparatus further includes a tension roller actuating mechanism that adjusts the position of the tension roller from the first position to the second position and from the second position to the first position so that the adjustable track length changes from the first length to the second length and from the second length to the first length; wherein the step of placing the adjustable track in the non-operative configuration includes actuating the tension roller actuating mechanism so that the position of the tension roller is adjusted from the first position to the second position and that the adjustable track length changes from the first length to the second length.

22. An advertising display device for displaying a continuous advertising medium; the continuous advertising medium having a thickness and an exterior surface displaying a series of adjacent images; the advertising display device comprising:
a tracking apparatus having a track for engagement of the continuous advertising medium, the tracking apparatus including a frame operatively connected with first and second rollers defining opposite ends of the adjustable track; one of the first and second rollers being a drive roller that provides a motive force that rotates the continuous advertising medium about the track when the continuous advertising medium is engaged with the track; and at least one source of light attached to the frame and positioned such that the at least one source of light is positioned between the first and second rollers in a manner in which the continuous advertising medium rotates around the light source when the continuous advertising medium is engaged with track, wherein light transmitted from the at least one light source backlights at least one of the series of adjacent advertising displays without passing through more than one thickness of the continuous advertising medium.

23. The advertising display device of claim 22, wherein the track is an adjustable track; each roller having a roller surface, the adjustable track having an operative configuration, a non-operative configuration and an adjustable track length; the adjustable track length being the distance between the most distal point on each of the respective roller surfaces; one of the first and second rollers being a tension roller that is adjustably connected to the frame; wherein the tension roller has first and second positions with respect to the frame and the tension roller can be adjusted so that it is in either of the first and second positions; the adjustable track being in the operative configuration when the tension; roller in the first position and in the non-operative configuration when the tension roller is in the second position; wherein the adjustable track length has a first length when the tension roller in the first position and a second length when the tension roller is in the second position; the first length being greater that the second length, the display device further including a housing; the tracking apparatus being pivotally interconnected with the housing, the housing having an enclosure body and an enclosure door; the enclosure door being pivotally interconnected with the enclosure body such that the enclosure door can pivot open so as to permit easy access to the pivotally attached tracking apparatus; wherein the housing provides an enclosure for the tracking apparatus which can be opened by opening the pivotal enclosure door to permit access to the tracking apparatus.

24. The advertising display device of claim 22, the housing having an enclosure body and an enclosure door; the enclosure door having a display opening through which an advertising display can be seen when the enclosure door is closed, the frame having a front and a back, the front being closer to the display opening than the back when the enclosure door is closed, the at least one source of light being positioned such that the at least one source of light is more removed from the front than from the back such that a first distance from the at least one source of light to a portion of the continuous advertising medium most proximate the enclosure door is greater than a second distance from the at least one source of light to a portion of the continuous advertising medium most proximate the back.

25. The advertising display device of claim 22, wherein the tracking apparatus further includes a tension roller actuating mechanism that adjusts the position of the tension roller from the first position to the second position and from the second position to the first position so that the adjustable track length changes from the first length to the second length and from the second length to the first length, wherein the tension roller actuating mechanism can be actuated such that the tension roller goes from the first position to the second position so that the continuous advertising medium can be easily disengaged from the adjustable track.

26. The advertising display device of claim 22, further comprising:
a sensor that senses movement, the drive roller having a drive actuator that causes the drive roller to provide the motive force to rotate the continuous advertising medium about the adjustable track, the sensor being operatively interconnected with the drive actuator such that the drive actuator is actuated when the sensor senses motion.

27. The advertising display device of claim 26, further comprising:
a timer interconnected with a drive actuator that causes the drive roller to provide the motive force to rotate the continuous advertising medium about the adjustable track, the timer being operatively interconnected with the drive actuator such that the drive roller will stop rotating the continuous advertising medium when a predetermined amount of time has elapsed.

28. The advertising display device of claim 22, further comprising:
a sensor that senses a predetermined event, the drive roller being interconnected with a drive actuator that causes the drive roller to provide the motive force to rotate the continuous advertising medium about the adjustable track, the sensor being operatively interconnected with the drive actuator such that the drive actuator is actuated when the sensor senses the predetermined event.

29. A continuous advertising medium for engagement with and advertising display device having a tracking apparatus providing a track for engagement of the continuous advertising medium, the tracking apparatus including a frame operatively connected with first and second rollers defining opposite ends of the adjustable track; one of the first and second rollers being a drive roller that provides a motive force that rotates the continuous advertising medium about the track when the continuous advertising medium is engaged with the track, the tracking apparatus including a sensor that senses a predetermined event, the drive roller being interconnected with a drive actuator that causes the drive roller to provide the motive force to rotate the continuous advertising medium about the adjustable track, the sensor being operatively interconnected with the drive actuator such that the drive actuator is actuated when the sensor senses the predetermined event, the continuous advertising medium comprising:
a sheet of sheet material having opposite ends with respect to a single dimension of the sheet material; the respective opposite ends of the sheet being joined together so that the sheet forms a continuous loop, the sheet material being sufficiently flexible to bend along a centerline running generally parallel to respective edges of the continuous loop, the sheet material having printed images on the sheet, the sheet material and the printed images allowing light to pass through the sheet material so a source of light behind the sheet can illuminate the images printed on the sheet, the sheet including a sensor activating structure selected from the group consisting of an opening intentionally placed at a specific location in the sheet material that allows undiffused light to pass through the sheet material; an area at a specific location on the sheet material, upon which ink is printed, which contrasts with surrounding background on the sheet, so as to provide an area at this specific location where reflected light from the specific location will be detectably different than light reflected from the surrounding background; a metallic member placed at a specific location on the sheet material and a magnetic member placed at a specific location on the sheet material; wherein the predetermined event is selected from the group consisting of rotation of the continuous advertising medium so that an opening intentionally placed at a specific location in the sheet material is positioned proximate the sensor so that undiffused light to pass through the sheet material and is detected by the sensor; rotation of the continuous advertising medium so that an area at a specific location on the sheet material, upon which ink is printed, which contrasts with surrounding background on the sheet is positioned proximate the sensor so that the sensor can detect a difference in reflected light as compared to light reflected from the surrounding background; rotation of the continuous advertising medium so that a metallic member placed at a specific location on the sheet material is positioned proximate the sensor so that the sensor can detect the proximity of the metallic member and rotation of the continuous advertising medium so that a magnetic member placed at a specific location on the sheet material is positioned proximate the sensor so that the sensor can detect the proximity of the magnetic member.

30. The continuous advertising medium of claim 29, the sheet material being substantially non-elastic.

31. A method of displaying images, comprising the steps of:
providing an advertising display device including a first continuous advertising medium; the continuous advertising medium having a thickness and a series of adjacent images; the series of images including first and second images; the advertising display device including a tracking apparatus and at least one source of light, the tracking apparatus providing an adjustable track for engagement of the continuous advertising medium, the tracking apparatus including a frame operatively connected with first and second rollers defining opposite ends of the adjustable track; one of the first and second rollers being a drive roller that provides a motive force that rotates the continuous advertising medium about the adjustable track when the continuous advertising medium is engaged with the adjustable track the at least one source of light being attached to the frame and positioned such that the at least one source of light is positioned between the first and second rollers in a manner in which the continuous advertising medium rotates around the light source when the continuous advertising medium is engaged with adjustable track, wherein light transmitted from the at least one light source backlights at least a portion of at least one of the series of adjacent images without passing through more than one thickness of the continuous advertising medium; the advertising display device including a housing; the housing having an enclosure body and an enclosure door; the enclosure door having a display opening through which at least a portion of at least one of the series of adjacent images can be observed when the enclosure door is closed; wherein the advertising display device includes a sensor that senses a predetermined event, the drive roller being interconnected with a drive actuator that causes the drive roller to provide the motive force to rotate the continuous advertising medium about the adjustable track, the sensor being operatively interconnected with the drive actuator such that the drive actuator is actuated when the sensor senses the predetermined event; and wherein the advertising display device has a timer that can be set for a predetermined length of time, the drive roller being interconnected with a drive actuator that causes the drive roller to provide the motive force to rotate the continuous advertising medium about the adjustable track, the timer being operatively interconnected with the drive actuator such that the drive actuator stops the drive roller from providing motive force when the predetermined length of time has elapsed; the sensor being a motion sensor and the predetermined event consists of motion which can be detected by the sensor;
placing the advertising display device in a place where motion is detected which actuates the drive actuator such that the continuous advertising medium rotates about the tracking apparatus for the predetermined length of time; wherein the predetermined length of time is set so that the second image can be observed through the display opening when the predetermined length of time concludes and the continuous advertising medium no longer rotates about the track until motion is detected again and the sensor actuates the drive roller again.
